(19) United States
(12) Patent Application Publication
(10) Pub. No.: US 2022/0244501 A1
(43) Pub. Date: Aug. 4, 2022

(54) Camera Lens Assembly

(71) Applicant: ZHEJIANG SUNNY OPTICS CO.,LTD., Ningbo (CN)

(72) Inventors: Binqing WANG, Ningbo (CN); Fujian DAI, Ningbo (CN); Liefeng ZHAO, Ningbo (CN)

(21) Appl. No.: 17/588,277

(22) Filed: Jan. 29, 2022

(30) Foreign Application Priority Data
Feb. 1, 2021 (CN) 202110137284.9

(51) Int. Cl. G02B 13/00; G02B 9/64

(52) U.S. Cl. CPC G02B 13/0045; G02B 9/64

(57) ABSTRACT

The disclosure provides a camera lens assembly, sequentially including from an object side to an image side along an optical axis: a first lens, a second lens, a third lens, a fourth lens, a fifth lens, a sixth lens, a seventh lens, an eighth lens, a ninth lens and a tenth lens, wherein the seventh lens has a positive refractive power; the eighth lens has a positive refractive power; an object-side surface of the ninth lens is concave surface, and an image-side surface of the ninth lens is convex surface; and ImgH is a half of a diagonal length of an effective pixel region on an imaging surface of the camera lens assembly, ImgH satisfies: ImgH>6 mm.

### CROSS-REFERENCE TO RELATED PRESENT INVENTION(S)

The disclosure claims priority to and the benefit of Chinese Patent Present invention No. 202110137284.9, filed in the China National Intellectual Property Administration (CNIPA) on 1 Feb. 2021, which is incorporated herein by reference in its entirety.

### TECHNICAL FIELD

The disclosure relates to the technical field of optical components, and more specifically, to a camera lens assembly.

### BACKGROUND

With the development of portable electronic products such as smart phones, people have put forward higher requirements for the performance of mobile phone camera lenses. A multi-piece camera lens assembly provides more design freedom, thus providing greater possibilities for improving shooting performance of the mobile phone. In addition, an f-number of a conventional lens is usually above 2.0, but in the case of rainy days, twilight, and other insufficient light conditions and hand shaking, the f-number above 2.0 is no longer sufficient for higher-order imaging requirements.

Therefore, in order to better adapt to market demands and a market trend of ultra-thin mobile phones, it is expected to provide a camera lens assembly with large aperture and ultra-thin characteristics suitable for portable electronic products.

### SUMMARY

The disclosure provides a camera lens assembly, sequentially including from an object side to an image side along an optical axis: a first lens, a second lens, a third lens, a fourth lens, a fifth lens, a sixth lens, a seventh lens, an eighth lens, a ninth lens and a tenth lens. The seventh lens has a positive refractive power; the eighth lens has a positive refractive power; and an object-side surface of the ninth lens is concave, and an image-side surface of the ninth lens is convex. ImgH is a half of a diagonal length of an effective pixel region on an imaging surface of the camera lens assembly, ImgH may satisfy: ImgH>6 mm.

In an implementation, an optical distortion DIST at a maximum field of view of the camera lens assembly may satisfy: |DIST|≤3%.

In an implementation, ImgH and an Entrance Pupil Diameter (EPD) of the camera lens assembly may satisfy: 1<ImgH/EPD<1.5.

In an implementation, TTL is an on-axis distance from an object-side surface of the first lens to the imaging surface, TTL and an f-number Fno of the camera lens assembly may satisfy: 5 mm<TTL/Fno<6 mm.

In an implementation, a curvature radius R1 of the object-side surface of the first lens and a curvature radius R2 of an image-side surface of the first lens may satisfy: 2<(R1+R2)/(R2−R1)<10.

In an implementation, a central thickness CT1 of the first lens and a central thickness CT2 of the second lens may satisfy: 1.5<CT1/CT2≤3.5.

In an implementation, an effective focal length f3 of the third lens, a curvature radius R5 of an object-side surface of the third lens, and a curvature radius R6 of an image-side surface of the third lens may satisfy: −8<f3/(R5−R6)<−2.

In an implementation, an effective focal length f of the camera lens assembly and an effective focal length f4 of the fourth lens may satisfy: 1<f/f4<2.5.

In an implementation, a central thickness CT5 of the fifth lens, a central thickness CT7 of the seventh lens, and an air space T45 between the fourth lens and the fifth lens on the optical axis may satisfy: 1<CT7/(CT5+T45)<2.5.

In an implementation, a curvature radius R17 of an object-side surface of the ninth lens and a curvature radius R18 of an image-side surface of the ninth lens may satisfy: 1<(R17+R18)/R17<3.5.

In an implementation, an effective focal length f of the camera lens assembly and an effective focal length f10 of the tenth lens may satisfy: −2<f/f10<0.

In an implementation, a central thickness CT6 of the sixth lens, a central thickness CT8 of the eighth lens, and an effective focal length f8 of the eighth lens may satisfy: 0<(CT6+CT8)/f8<0.1.

The disclosure adopts a ten-piece lens structure. Through reasonable distribution of optical power and optimized selection of surface type and thickness, this ensures that the camera lens assembly has the feature of large image plane, and also conducive to the large aperture and ultra-thin features of the camera lens assembly.

### BRIEF DESCRIPTION OF THE DRAWINGS

With reference to the accompanying drawings, through the following detailed description of non-limitative implementations, other features, purposes, and advantages of the disclosure will become more apparent. In the drawings:

FIG. 1 is a schematic structural diagram of a camera lens assembly according to Embodiment 1 of the disclosure; FIG. 2A to FIG. 2D respectively show a longitudinal aberration curve, an astigmatism curve, a distortion curve and a lateral color curve of a camera lens assembly according to Embodiment 1 of the disclosure;

FIG. 3 is a schematic structural diagram of a camera lens assembly according to Embodiment 2 of the disclosure; FIG. 4A to FIG. 4D respectively show a longitudinal aberration curve, an astigmatism curve, a distortion curve and a lateral color curve of a camera lens assembly according to Embodiment 2 of the disclosure;

FIG. 5 is a schematic structural diagram of a camera lens assembly according to Embodiment 3 of the disclosure; FIG. 6A to FIG. 6D respectively show a longitudinal aberration curve, an astigmatism curve, a distortion curve and a lateral color curve of the camera lens assembly according to Embodiment 3 of the disclosure;

FIG. 7 is a schematic structural diagram of a camera lens assembly according to Embodiment 4 of the disclosure; FIG. 8A to FIG. 8D respectively show a longitudinal aberration curve, an astigmatism curve, a distortion curve and a lateral color curve of the camera lens assembly according to Embodiment 4 of the disclosure;

FIG. 9 is a schematic structural diagram of a camera lens assembly according to Embodiment 5 of the disclosure; FIG. 10A to FIG. 10D respectively show a longitudinal aberration curve, an astigmatism curve, a distortion curve and a lateral color curve of a camera lens assembly according to Embodiment 5 of the disclosure;

FIG. 11 is a schematic structural diagram of a camera lens assembly according to Embodiment 6 of the disclosure; FIG. 12A to FIG. 12D respectively show a longitudinal aberration curve, an astigmatism curve, a distortion curve and a lateral color curve of the camera lens assembly according to Embodiment 6 of the disclosure;

FIG. 13 is a schematic structural diagram of a camera lens assembly according to Embodiment 7 of the disclosure; FIG. 14A to FIG. 14D respectively show a longitudinal aberration curve, an astigmatism curve, a distortion curve and a lateral color curve of the camera lens assembly according to Embodiment 7 of the disclosure;

FIG. 15 is a schematic structural diagram of a camera lens assembly according to Embodiment 8 of the disclosure; and FIG. 16A to FIG. 16D respectively show a longitudinal aberration curve, an astigmatism curve, a distortion curve and a lateral color curve, and a distortion curve of a camera lens assembly according to Embodiment 8 of the disclosure.

### DETAILED DESCRIPTION OF THE EMBODIMENTS

For a better understanding of the disclosure, various aspects of the disclosure will be described in more detail with reference to the accompanying drawings. It should be understood that these detailed descriptions only describe exemplary embodiment of the disclosure, and are not intended to limit the scope of the disclosure in any manner. Throughout the specification, same reference numerals refer to same elements. The expression “and/or” includes any and all combinations of one or more of the associated listed items.

It should be noted that in this specification, expressions such as first, second, third, and the like are only used to distinguish one feature from another feature, and do not represent any limitation on the feature. Therefore, without departing from the teachings of the disclosure, the first lens discussed below may also be referred to as a second lens or a third lens.

In the accompanying drawings, the thickness, size, and shape of the lens have been slightly exaggerated for ease of description. Specifically, a shape of the spherical or aspheric surface shown in the accompanying drawings is shown in examples. That is, the shape of the spherical or aspheric surface is not limited to the shape of the spherical or aspheric surface shown in the accompanying drawings. The accompanying drawings are only examples and are not drawn strictly to scale.

In this specification, a paraxial region refers to an area near the optical axis. If a lens surface is convex and a position of the convex surface is not defined, it indicates that the lens surface is convex at least in the paraxial region; if the lens surface is concave and a position of the concave surface is not defined, it indicates that the lens surface is concave at least in the paraxial region. In this specification, a surface of each lens closest to an object to be photographed is called an object-side surface of the lens, and a surface of each lens closest to an imaging surface is called an image-side surface of the lens.

It should also be understood that terms “include”, “including”, “have”, “contain”, and/or “containing”, used in the specification, represent existence of a stated characteristic, component and/or part but do not exclude existence or addition of one or more other characteristics, components and parts and/or combinations thereof. In addition, expressions like “at least one in . . . ” may appear after a list of listed characteristics not to modify an individual component in the list but to modify the listed characteristics. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used herein have the same meanings as commonly understood by those of ordinary skill in the art to which the disclosure belongs. It should also be understood that terms (such as those defined in common dictionaries) should be interpreted to have meanings consistent with meanings thereof in the context of related technologies, and will not be interpreted in an idealized or overly formal sense, unless specifically defined as such in this specification.

It is to be noted that the embodiments in the disclosure and characteristics in the embodiments may be combined without conflicts. The characteristics, principles and other aspects of the disclosure will be described below with reference to the drawings and in combination with the embodiments in detail. The features, principles and other aspects of the disclosure will be described in detail below.

The camera lens assembly according to an exemplary embodiment of the disclosure may include, for example, ten lenses having refractive power, namely, a first lens, a second lens, a third lens, a fourth lens, a fifth lens, a sixth lens, a seventh lens, an eighth lens, a ninth lens, and a tenth lens. The ten lenses are arranged in order from an object side to an image side along the optical axis.

In an exemplary embodiment, the first lens has a positive refractive power or a negative refractive power; the second lens has a positive refractive power or a negative refractive power; the third lens has a positive refractive power or a negative refractive power; the fourth lens has a positive refractive power or a negative refractive power; the fifth lens has a positive refractive power or a negative refractive power; the sixth lens has a positive refractive power or a negative refractive power; the seventh lens may have a positive refractive power; the eighth lens may have a positive refractive power; the ninth lens has a positive refractive power or a negative refractive power; and the tenth lens has a positive refractive power or a negative refractive power. By reasonably distributing a refractive power of each lens of the camera lens assembly, the feature of large image plane of the camera lens assembly may be ensured, and it is beneficial to compress an incident angle of a ray at a position of a stop, reduce pupil aberration, and improve imaging quality.

In an exemplary embodiment, the camera lens assembly of the disclosure may satisfy a conditional formula |DIST|≤3%, where DIST is an optical distortion at a maximum field of view of the camera lens assembly. By optimizing the surface type and thickness of the lens, it is ensured that the optical distortion of the camera lens assembly within the maximum field of view is less than or equal to 3%, namely, |DIST|≤3%. If |DIST|≤3%, small distortion characteristics of the camera lens assembly may be realized, and the imaging quality may be improved. More specifically, DIST may satisfy |DIST|≤2.1%.

In an exemplary embodiment, the camera lens assembly of the disclosure may satisfy a conditional formula 1<ImgH/EPD<1.5, where ImgH is a half of a diagonal length of an effective pixel region on an imaging surface of the camera lens assembly, and EPD is an entrance pupil diameter of the camera lens assembly. By controlling a ratio of the image height to the entrance pupil diameter that are of the camera lens assembly to be in this range, the feature of large image plane of the camera lens assembly may be ensured, and light flux and relative illumination may also be improved. More specifically, a ratio of ImgH to EPD may satisfy 1.4<ImgH/EPD<1.5.

In an exemplary embodiment, the camera lens assembly of the disclosure may satisfy a conditional formula f×tan(Semi-FOV)>5.8 mm, where f is an effective focal length of the camera lens assembly, and Semi-FOV is a half of the maximum field of view of the camera lens assembly. By controlling a product of the focal length and the field of view that are of the camera lens assembly, the feature of large image plane of the camera lens assembly is ensured. For example, f and Semi-FOV may satisfy 5.8 mm<f×tan(Semi-FOV)<6.2 mm.

In an exemplary embodiment, the camera lens assembly of the disclosure may satisfy a conditional formula 5 mm<TTL/Fno<6 mm, where TTL is an on-axis distance from an object-side surface of the first lens to the imaging surface, and Fno is an f-number of the camera lens assembly. Controlling a ratio of a total length of the camera lens assembly to the f-number of the camera lens assembly to be in this range may be beneficial to miniaturization of the lens, may ensure the light flux and the relative illumination of the lens, and strengthen an imaging effect in dark environment. More specifically, TTL and Fno may satisfy 5.2 mm<TTL/Fno<5.6 mm.

In an exemplary embodiment, the camera lens assembly of the disclosure may satisfy a conditional formula 2<(R1+R2)/(R2−R1)<10, where R1 is a curvature radius of the object-side surface of the first lens, and R2 is a curvature radius of the image-side surface of the first lens. By controlling values of the curvature radiuses of the object-side surface and the image-side surface of the first lens to satisfy 2<(R1+R2)/(R2−R1)<10, the first lens of the camera lens assembly may have a more reasonable shape, and a system optical power may be reasonably assumed to balance aberrations produced by the following lenses. More specifically, R1 and R2 may satisfy: 2.40<(R1+R2)/(R2−R1)<9.05.

In an exemplary embodiment, the camera lens assembly of the disclosure may satisfy a conditional formula 1.5<CT1/CT2≤3.5, where CT1 is a central thickness of the first lens, and CT2 is a central thickness of the second lens. By controlling a ratio of the center thickness of the first lens to the center thickness of the second lens to be in this range, the first lens and the second lens of the camera lens assembly may have a more reasonable shape, and the system optical power may be reasonably assumed to balance aberrations produced by the following lenses. More specifically, CT1 and CT2 may satisfy 1.66<CT1/CT2≤3.24.

In an exemplary embodiment, the camera lens assembly of the disclosure may satisfy a conditional formula −8<f3/(R5−R6)<−2, where f3 is an effective focal length of the third lens, R5 is a curvature radius of an object-side surface of the third lens, and R6 is a curvature radius of an image-side surface of the third lens. By controlling a ratio of the effective focal length of the third lens to a difference between the curvature radius of the object-side surface of the third lens and the curvature radius of the image-side surface of the third lens to be in this range, field curvature contribution of the object-side surface and the image-side surface that are of the third lens may be in a reasonable range to balance field curvature generated by the foregoing lenses. More specifically, f3, R5, and R6 may satisfy: −7.62<f3/(R5−R6)<−2.28.

In an exemplary embodiment, the camera lens assembly of the disclosure may satisfy a conditional formula 1<f/f4<2.5, where f is the effective focal length of the camera lens assembly, and f4 is an effective focal length of the fourth lens. By controlling a ratio of the effective focal length of the camera lens assembly to the effective focal length of the fourth lens to be in this range, an optical power generated by the fourth lens may be balanced with an optical power generated by a front optical lens group to reduce aberrations and improve imaging quality. More specifically, f and f4 may satisfy 1.73<f/f4<2.33.

In an exemplary embodiment, the camera lens assembly of the disclosure may satisfy a conditional formula 1<CT7/(CT5+T45)<2.5, where CT5 is a center thickness of the fifth lens, CT7 is a center thickness of the seventh lens, and T45 is an air space between the fourth lens and the fifth lens on the optical axis. By controlling the center thickness of the fifth lens, the center thickness of the seventh lens, and the air space between the fourth lens and the fifth lens to satisfy 1<CT7/(CT5+T45)<2.5, manufacturability of the lens may be ensured, and problems such as excessively thin lenses that cause instability in molding and assembly, or excessively thick lenses that cause excessive internal stress may be avoided. More specifically, CT5, CT7, and T45 may satisfy 1.38<CT7/(CT5+T45)<2.36.

In an exemplary embodiment, the camera lens assembly of the disclosure may satisfy a conditional formula 1<(R17+R18)/R17<3.5, where R17 is a curvature radius of an object-side surface of the ninth lens, and R18 is a curvature radius of an image-side surface of the ninth lens. By controlling values of the curvature radius of the object-side surface of the ninth lens and the curvature radius of the image-side surface of the ninth lens to satisfy 1<(R17+R18)/R17<3.5, a trend of a thickness ratio of an aspheric surface of the ninth lens may be well controlled. Therefore, imaging quality of an on-axis field of view and imaging quality of an off-axis field of view will not be significantly degraded due to contribution of coma. More specifically, R17 and R18 may satisfy 1.88<(R17+R18)/R17<3.25.

In an exemplary embodiment, the camera lens assembly of the disclosure may satisfy a conditional formula −2<f/f10<0, where f is the effective focal length of the camera lens assembly, and f10 is an effective focal length of the tenth lens. By controlling a ratio of the effective focal length of the camera lens assembly to the effective focal length of the tenth lens to be in this range, contribution of spherical aberration of the tenth lens may be effectively controlled to be within a reasonable level, so that the on-axis field of view may have good imaging quality. More specifically, f and f10 may satisfy −1.60<f/f10<−1.30.

In an exemplary embodiment, the camera lens assembly of the disclosure may satisfy a conditional formula 0<(CT6+CT8)/f8<0.1, where CT6 is a central thickness of the sixth lens, CT8 is a central thickness of the eighth lens, and f8 is an effective focal length of the eighth lens. By controlling the thickness of the sixth lens, the thickness of the eighth lens, and the focal length of the eighth lens to satisfy 0<(CT6+CT8)/f8<0.1, on the one hand, rays may be better converged to obtain a larger image plane, and on the other hand, it may avoid that the eighth lens is too thick, causing the optical power to be too concentrated, which is not conducive to aberration correction of the entire system. More specifically, CT6, CT8, and f8 may satisfy 0.03<(CT6+CT8)/f8<0.09.

In an exemplary embodiment, the foregoing camera lens assembly may further include at least one stop. The diaphragm may be arranged at an appropriate position as required, for example, between the object side and the first lens. Optionally, the foregoing camera lens assembly may further include a optical filter for correcting color deviation and/or a sheet of protective glass for protecting a photosensitive element located on the imaging surface.

The camera lens assembly according to the foregoing implementation of the disclosure may use a plurality of lenses, for example, ten lenses as described above. By reasonably distributing an optical power, a surface type, a center thickness of each lens, an on-axis distance between lenses, and the like, the feature of large image plane of the lens may be effectively ensured, light flux and relative illumination are improved, aberrations are balanced, and imaging quality is improved to ensure manufacturability of the lens and be conducive to miniaturization of the lens. This makes the camera lens assembly more suitable for the ever-developing portable electronic products. The camera lens assembly with the foregoing configuration has large aperture and ultra-thin characteristics. On the premise of a large image plane, the larger the aperture, the greater the light admitted, thus may effectively increase a shutter speed, while a background blur effect is better. In addition, the ultra-thin characteristics of the camera lens assembly may ensure the ultra-thinness of portable electronic products such as mobile phones under the premise of fully improving the optical performance, so as to better meet the demands of the market.

In the implementation of the disclosure, at least one mirror lens of each lens is an aspheric mirror lens, that is, at least one mirror surface from the object-side surface of the first lens to the image-side surface of the tenth lens is an aspheric mirror surface. The characteristic of the aspheric lens is that the curvature changes continuously from the center to the periphery of the lens. Unlike the spherical lens with a constant curvature from the center to the periphery of the lens, the aspheric lens has better curvature radius characteristics and has an advantage of improving distorted aberrations, namely, improving astigmatic aberrations. By using the aspheric lens, the aberrations that occur during imaging can be eliminated as much as possible, thereby improving the imaging quality. Optionally, at least one of an object-side surface and an image-side surface of each lens of the first lens, the second lens, the third lens, the fourth lens, the fifth lens, the sixth lens, the seventh lens, the eighth lens, the ninth lens, and the tenth lens is the aspheric mirror surface. Optionally, both an object-side surface and an image-side surface of each lens of the first lens, the second lens, the third lens, the fourth lens, the fifth lens, the sixth lens, the seventh lens, the eighth lens, the ninth lens, and the tenth lens are aspheric mirror surfaces.

However, those skilled in the art should understand that, without departing from the technical solution claimed in the disclosure, a quantity of lenses of the camera lens assembly may be changed to obtain various results and advantages described in this specification. For example, although ten lenses have been described as an example in the implementation, the camera lens assembly is not limited to including ten lenses. If necessary, the camera lens assembly may also include other quantity of lenses.

Specific embodiments of the camera lens assembly applicable to the above embodiments will be further described below with reference to the accompanying drawings.

### Embodiment 1

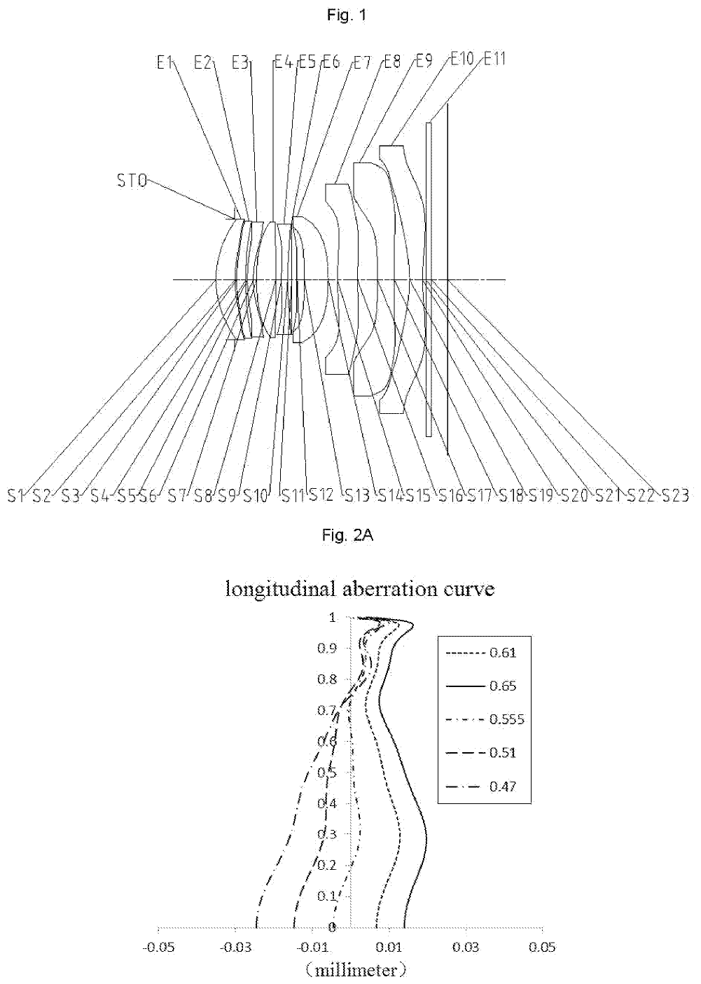

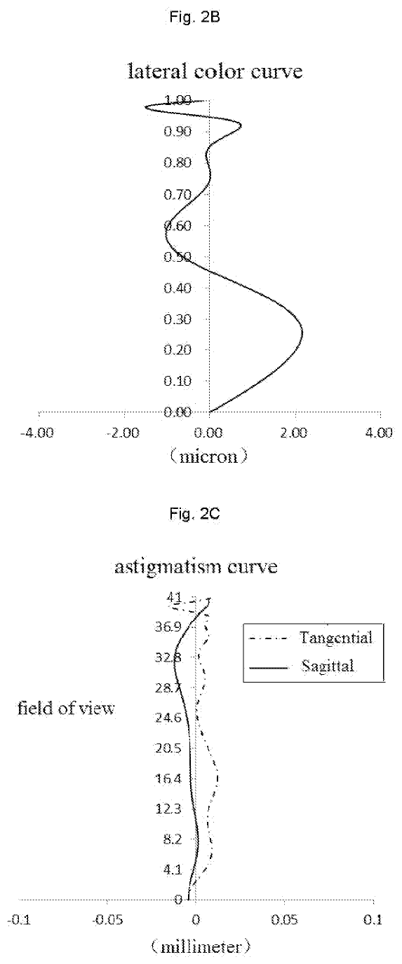

The following describes the camera lens assembly of Embodiment 1 of the disclosure with reference to FIG. 1 to FIG. 2D. FIG. 1 is a schematic structural diagram of a camera lens assembly according to Embodiment 1 of the disclosure.

As shown in FIG. 1, the camera lens assembly includes a diaphragm STO, a first lens E1, a second lens E2, a third lens E3, a fourth lens E4, a fifth lens E5, a sixth lens E6, a seventh lens E7, an eighth lens E8, a ninth lens E9, a tenth lens E10, and a optical filter E11 in sequence from an object side to an image side along an optical axis.

The first lens E1 has a positive refractive power, an object-side surface S1 of the first lens is convex surface, and an image-side surface S2 of the first lens is concave surface. The second lens E2 has a positive refractive power, an object-side surface S3 of the second lens is convex surface, and an image-side surface S4 of the second lens is concave surface. The third lens E3 has a negative refractive power, an object-side surface S5 of the third lens is convex surface, and an image-side surface S6 of the third lens is concave surface. The fourth lens E4 has a positive refractive power, an object-side surface S7 of the fourth lens is convex surface, and an image-side surface S8 of the fourth lens is convex surface. The fifth lens E5 has a negative refractive power, an object-side surface S9 of the fifth lens is convex surface, and an image-side surface S10 of the fifth lens is concave surface. The sixth lens E6 has a negative refractive power, an object-side surface S11 of the sixth lens is convex surface, and an image-side surface S12 of the sixth lens is concave surface. The seventh lens E7 has a positive refractive power, an object-side surface S13 of the seventh lens is concave surface, and an image-side surface S14 of the seventh lens is convex surface. The eighth lens E8 has a positive refractive power, an object-side surface S15 of the eighth lens is convex surface, and an image-side surface S16 of the eighth lens is convex surface. The ninth lens E9 has a positive refractive power, an object-side surface S17 of the ninth lens is concave surface, and an image-side surface S18 of the ninth lens is convex surface. The tenth lens E10 has a negative refractive power, an object-side surface S19 of the tenth lens is concave surface, and an image-side surface S20 of the tenth lens is concave surface. The optical filter E11 has an object-side surface S21 and an image-side surface S22. The camera lens assembly has an imaging surface S23, and a light from an object sequentially passes through the surface S1 to the surface S22 and finally imaged on the imaging surface S23.

Table 1 shows basic parameters of the camera lens assembly of Embodiment 1, where both a curvature radius and a thickness/distance are in millimeters (mm).

TABLE 1

| | | | | Material | | |
|---|---|---|---|---|---|---|
| Surface | Surface | Curvature | Thickness/ | Refractive | Abbe | Conic |
| number | type | radius | distance | index | number | coefficient |
| OBJ | Spherical | Infinite | Infinite | | | |
| STO | Spherical | Infinite | −0.6392 | | | |
| S1 | Aspheric | 3.5579 | 0.5574 | 1.54 | 56.09 | −0.1406 |
| S2 | Aspheric | 4.5916 | 0.1063 | | | −0.0517 |
| S3 | Aspheric | 4.7620 | 0.4060 | 1.55 | 54.49 | 0.6239 |
| S4 | Aspheric | 29.6748 | 0.0500 | | | −99.0000 |
| S5 | Aspheric | 4.6169 | 0.2384 | 1.66 | 20.37 | −0.0367 |
| S6 | Aspheric | 2.9768 | 0.1540 | | | −0.0017 |
| S7 | Aspheric | 35.3739 | 0.6954 | 1.54 | 56.09 | −74.7391 |
| S8 | Aspheric | −41.1035 | 0.0500 | | | 82.7869 |
| S9 | Aspheric | 5.1902 | 0.3176 | 1.63 | 23.98 | −0.1959 |
| S10 | Aspheric | 15.9983 | 0.0500 | | | −4.9504 |
| S11 | Aspheric | 10.6369 | 0.2100 | 1.66 | 20.37 | −1.4081 |
| S12 | Aspheric | 4.5742 | 0.6314 | | | −0.0425 |
| S13 | Aspheric | −31.3454 | 0.9910 | 1.58 | 35.27 | −99.0000 |
| S14 | Aspheric | −7.3362 | 0.3549 | | | −12.3727 |
| S15 | Aspheric | 32.7025 | 0.7549 | 1.64 | 21.45 | 97.7259 |
| S16 | Aspheric | −10.9596 | 1.3033 | | | 0.5404 |
| S17 | Aspheric | −8.8565 | 0.4224 | 1.66 | 20.37 | −5.3606 |
| S18 | Aspheric | −11.4632 | 0.3623 | | | 1.9942 |
| S19 | Aspheric | −5.3520 | 0.3936 | 1.67 | 18.99 | −0.2745 |
| S20 | Aspheric | 8.7594 | 0.1103 | | | 1.0941 |
| S21 | Spherical | Infinite | 0.2100 | 1.52 | 54.20 | |
| S22 | Spherical | Infinite | 0.6000 | | | |
| S23 | Spherical | Infinite | | | | |

In Embodiment 1, a total effective focal length f of the camera lens assembly is 6.87 mm, ImgH is a half of a diagonal length of an effective pixel region on the imaging surface S23, ImgH is 6.06 mm, and FOV is a maximum field of view, FOV is 81.65°.

In Embodiment 1, both of an object-side surface and an image-side surface of any one of the first lens E1 to the tenth lens E10 are aspheric surfaces, and a surface type x of each aspheric lens may be defined by but not limited to the following aspheric surface formula:

$$x = \frac{{ch}^{2}}{1 + \sqrt{1 - ( k + 1 ) {c}^{2} {h}^{2}}} + \sum {Aih}^{i} \qquad ( 1 )$$

wherein x is a vector height of a distance between the aspheric surface and a vertex of the aspheric surface when the aspheric surface is located at a position with the height h in the optical axis direction, and c=1/R (that is, the paraxial curvature c is an inverse of radius of curvature R in Table 1 above; k is a Conic coefficient; and Ai is a correction coefficient of an i-th order of the aspheric surface. Table 2 below shows high-order coefficients A4, A6, A8, A10, A12, A14, A16, A18, and A20 that may be used for each aspheric mirror surface S1 to S20 in Embodiment 1.

TABLE 2

| Surface | | | | | |
|---|---|---|---|---|---|
| number | A4 | A6 | A8 | A10 | A12 |
| S1 | −3.5637E−03 | 2.2353E−03 | −2.7603E−03 | 1.7216E−03 | −6.6995E−04 |
| S2 | −1.3153E−02 | 1.3665E−02 | −1.8315E−02 | 1.1167E−02 | −3.6324E−03 |
| S3 | −5.4423E−03 | 1.8687E−02 | −2.4415E−02 | 1.3121E−02 | −3.5682E−03 |
| S4 | 4.4834E−02 | −1.7261E−02 | 8.8347E−03 | −7.5677E−03 | 5.0903E−03 |
| S5 | −1.0610E−02 | −1.2858E−02 | 1.3368E−02 | −7.2196E−03 | 2.9424E−03 |
| S6 | −3.5442E−02 | 4.3618E−03 | −4.2964E−04 | 4.8658E−04 | −3.2073E−04 |
| S7 | 4.0301E−02 | −1.1262E−02 | 2.5364E−03 | −8.5194E−04 | 6.1576E−04 |
| S8 | 1.4053E−02 | −7.0193E−03 | 8.2552E−04 | 7.6997E−04 | −8.5395E−04 |
| S9 | −3.0464E−02 | 8.2230E−03 | −3.4681E−03 | 2.5333E−03 | −2.6082E−03 |
| S10 | −3.5022E−02 | 3.4704E−02 | −4.2580E−03 | −1.3084E−02 | 1.0940E−02 |
| S11 | −2.3494E−02 | 2.5790E−02 | −4.7835E−03 | −1.1573E−02 | 1.0940E−02 |
| S12 | −1.1806E−02 | −2.5557E−04 | 1.4597E−03 | −2.5591E−03 | 1.8599E−03 |
| S13 | −8.1790E−03 | 7.1329E−04 | −2.3195E−04 | −6.9240E−04 | 6.8602E−04 |
| S14 | −2.1824E−02 | −1.4853E−04 | 2.0279E−03 | −1.5529E−03 | 6.8622E−04 |
| S15 | −8.3220E−03 | −1.8667E−03 | 1.0404E−03 | −3.7466E−04 | 9.9800E−05 |
| S16 | 6.4409E−03 | −2.9964E−03 | 7.0050E−04 | −1.3667E−04 | 2.5144E−05 |
| S17 | −2.2215E−03 | −1.3271E−03 | 3.5427E−05 | 3.0590E−05 | −4.3203E−06 |
| S18 | 5.0855E−03 | −2.4597E−03 | 9.0251E−04 | −1.6881E−04 | 1.8484E−05 |
| S19 | −7.8358E−03 | 2.9466E−03 | −3.7782E−05 | −5.9531E−05 | 9.2329E−06 |
| S20 | −1.8177E−02 | 3.8918E−03 | −6.7306E−04 | 7.8329E−05 | −6.0848E−06 |

| Surface | | | | |
|---|---|---|---|---|
| number | A14 | A16 | A18 | A20 |
| S1 | 1.6160E−04 | −2.2773E−05 | 1.6806E−06 | −4.9223E−08 |
| S2 | 6.4877E−04 | −5.1442E−05 | −6.3442E−07 | 2.5356E−07 |
| S3 | 4.2338E−04 | 1.6280E−05 | −9.6368E−06 | 7.2880E−07 |
| S4 | −2.1426E−03 | 5.2457E−04 | −6.8083E−05 | 3.6222E−06 |
| S5 | −1.0112E−03 | 2.4418E−04 | −3.3051E−05 | 1.8405E−06 |
| S6 | 5.7660E−05 | 4.3047E−06 | −2.3942E−06 | 2.0224E−07 |
| S7 | −2.7001E−04 | 6.0413E−05 | −6.5575E−06 | 2.6965E−07 |
| S8 | 4.6000E−04 | −1.2908E−04 | 1.8125E−05 | −10185E−06 |
| S9 | 1.4790E−03 | −4.2908E−04 | 6.2068E−05 | −3.5708E−06 |
| S10 | −4.3184E−03 | 9.6709E−04 | −1.1902E−04 | 6.3392E−06 |
| S11 | −4.6526E−03 | 1.0880E−03 | −1.3563E−04 | 7.0798E−06 |
| S12 | −6.9657E−04 | 1.4283E−04 | −1.4945E−05 | 6.1155E−07 |
| S13 | −3.5122E−04 | 1.0269E−04 | −1.6352E−05 | 1.1116E−06 |
| S14 | −1.9698E−04 | 3.5637E−05 | −3.7162E−06 | 1.7150E−07 |
| S15 | −1.7032E−05 | 1.7327E−06 | −9.5659E−08 | 2.2018E−09 |
| S16 | −3.3135E−06 | 2.6183E−07 | −1.1062E−08 | 1.9081E−10 |
| S17 | 3.7497E−07 | −2.7828E−08 | 1.3373E−09 | −2.6913E−11 |
| S18 | −1.2543E−06 | 5.1858E−08 | −1.1933E−09 | 1.1697E−11 |
| S19 | −6.9627E−07 | 2.9750E−08 | −6.8859E−10 | 6.7156E−12 |
| S20 | 3.1217E−07 | −10105E−08 | 1.8609E−10 | −1.4817E−12 |

FIG. 2A shows an a longitudinal aberration curve of a camera lens assembly of Embodiment 1, and the longitudinal aberration curve represents a convergence focus deviation formed when different wavelengths of light pass through the lens. FIG. 2B shows a lateral color curve of a camera lens assembly of Embodiment 1, and the lateral color curve represents a deviation of different image heights on an imaging surface when a light passes through the lens. FIG. 2C shows an astigmatism curve of a camera lens assembly of Embodiment 1, and the astigmatism curve represents tangential image surface curvature and sagittal image surface curvature. FIG. 2D shows a distortion curve of a camera lens assembly of Embodiment 1, and the distortion curve represents distortion values corresponding to different fields of view. It may be seen according to FIG. 2A to FIG. 2D that the camera lens assembly provided in Embodiment 1 can achieve good imaging quality.

### Embodiment 2

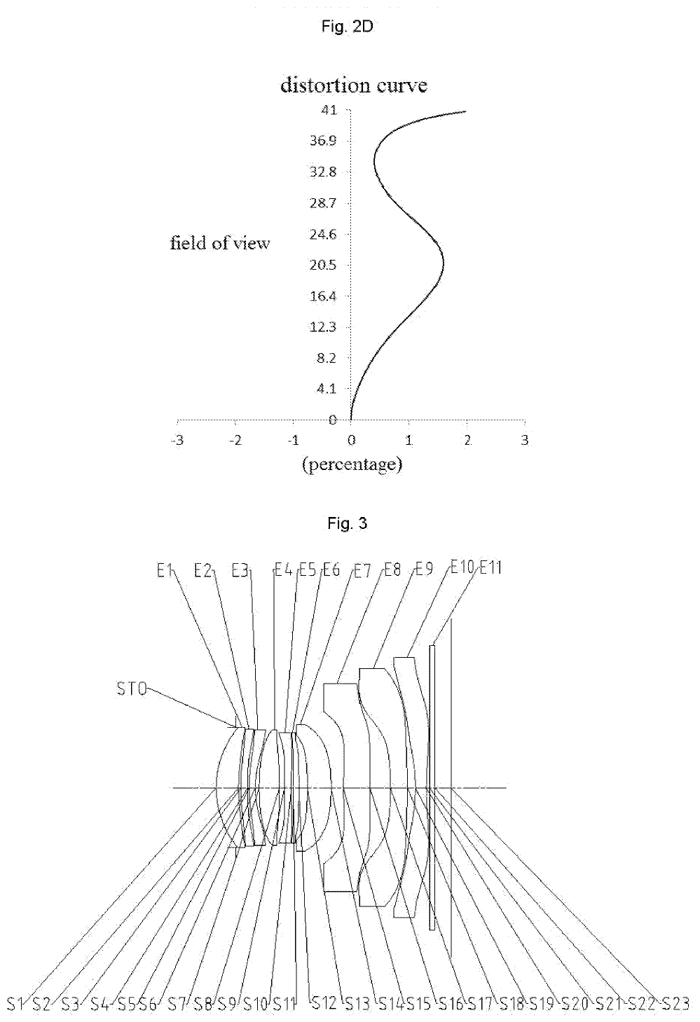

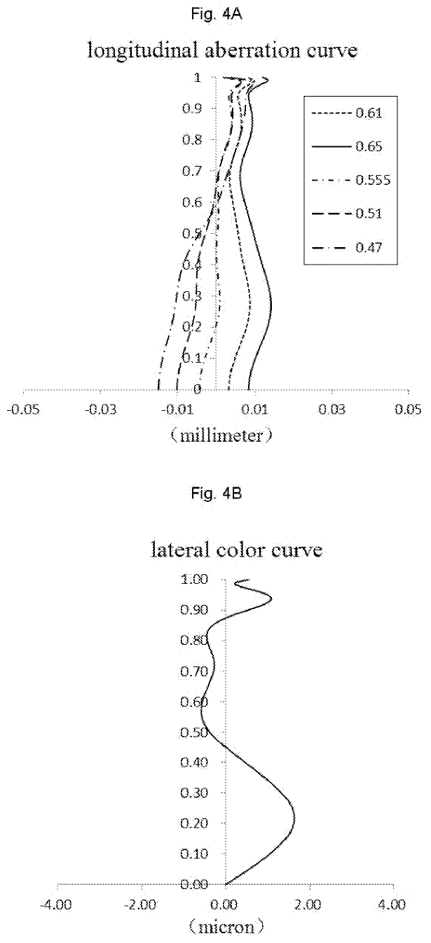

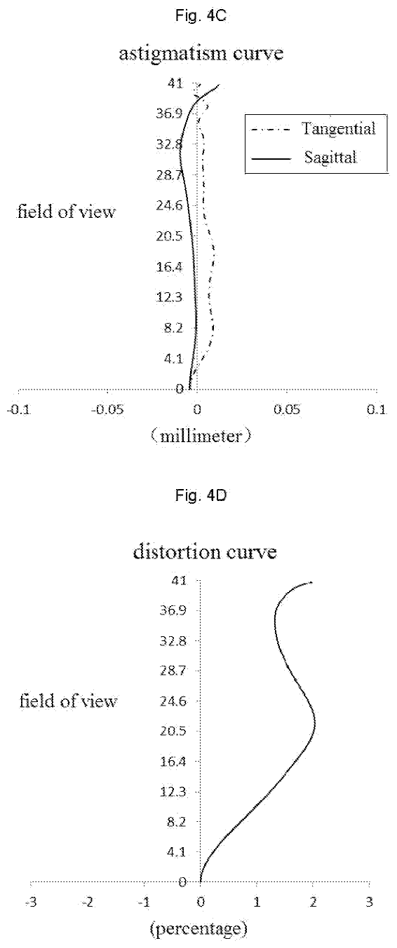

The following describes the camera lens assembly of Embodiment 2 of the disclosure with reference to FIG. 3 to FIG. 4D. In this embodiment and the following embodiments, for brevity, some descriptions similar to those in Embodiment 1 will be omitted. FIG. 3 is a schematic structural diagram of a camera lens assembly according to Embodiment 2 of the disclosure.

As shown in FIG. 3, the camera lens assembly includes a diaphragm STO, a first lens E1, a second lens E2, a third lens E3, a fourth lens E4, a fifth lens E5, a sixth lens E6, a seventh lens E7, an eighth lens E8, a ninth lens E9, a tenth lens E10, and a optical filter E11 in sequence from an object side to an image side along an optical axis.

The first lens E1 has a positive refractive power, an object-side surface S1 of the first lens is convex surface, and an image-side surface S2 of the first lens is concave surface. The second lens E2 has a positive refractive power, an object-side surface S3 of the second lens is convex surface, and an image-side surface S4 of the second lens is concave surface. The third lens E3 has a negative refractive power, an object-side surface S5 of the third lens is convex surface, and an image-side surface S6 of the third lens is concave surface. The fourth lens E4 has a positive refractive power, an object-side surface S7 of the fourth lens is convex surface, and an image-side surface S8 of the fourth lens is convex surface. The fifth lens E5 has a positive refractive power, an object-side surface S9 of the fifth lens is convex surface, and an image-side surface S10 of the fifth lens is concave surface. The sixth lens E6 has a negative refractive power, an object-side surface S11 of the sixth lens is concave surface, and an image-side surface S12 of the sixth lens is concave surface. The seventh lens E7 has a positive refractive power, an object-side surface S13 of the seventh lens is concave surface, and an image-side surface S14 of the seventh lens is convex surface. The eighth lens E8 has a positive refractive power, an object-side surface S15 of the eighth lens is convex surface, and an image-side surface S16 of the eighth lens is convex surface. The ninth lens E9 has a negative refractive power, an object-side surface S17 of the ninth lens is concave surface, and an image-side surface S18 of the ninth lens is convex surface. The tenth lens E10 has a negative refractive power, an object-side surface S19 of the tenth lens is concave surface, and an image-side surface S20 of the tenth lens is concave surface. The optical filter E11 has an object-side surface S21 and an image-side surface S22. The camera lens assembly has an imaging surface S23, and a light from an object sequentially passes through the surface S1 to the surface S22 and finally imaged on the imaging surface S23.

In Embodiment 2, a total effective focal length f of the camera lens assembly is 6.96 mm, ImgH is a half of a diagonal length of an effective pixel region on the imaging surface S23, ImgH is 6.14 mm, and FOV is a maximum field of view, FOV is 81.65°.

Table 3 shows basic parameters of the camera lens assembly of Embodiment 2, where both a curvature radius and a thickness/distance are in millimeters (mm). Table 4 shows high-order coefficients that may be used for all aspheric mirror surfaces in Embodiment 2, where each aspheric surface type may be defined by the formula (1) in the Embodiment 1.

TABLE 3

| | | | | Material | | |
|---|---|---|---|---|---|---|
| Surface | Surface | Curvature | Thickness/ | Refractive | Abbe | Conic |
| number | type | radius | distance | index | number | coefficient |
| OBJ | Spherical | Infinite | Infinite | | | |
| STO | Spherical | Infinite | −0.7534 | | | |
| S1 | Aspheric | 3.2190 | 0.8350 | 1.54 | 56.10 | −0.0479 |
| S2 | Aspheric | 5.8974 | 0.0889 | | | −0.6483 |
| S3 | Aspheric | 7.7186 | 0.2589 | 1.57 | 39.60 | 1.3455 |
| S4 | Aspheric | 40.7488 | 0.0506 | | | −61.3098 |
| S5 | Aspheric | 4.5972 | 0.2314 | 1.66 | 20.40 | −1.1664 |
| S6 | Aspheric | 2.8375 | 0.1565 | | | −0.1310 |
| S7 | Aspheric | 10.0509 | 0.7536 | 1.54 | 56.10 | −92.8510 |
| S8 | Aspheric | −20.1273 | 0.1981 | | | 53.3552 |
| S9 | Aspheric | 42.3990 | 0.2509 | 1.64 | 23.80 | 61.6270 |
| S10 | Aspheric | 69.8399 | 0.0796 | | | −98.9969 |
| S11 | Aspheric | −46.9504 | 0.2100 | 1.66 | 20.40 | −42.1456 |
| S12 | Aspheric | 134.8333 | 0.3096 | | | −75.1142 |
| S13 | Aspheric | −17.9982 | 0.9000 | 1.59 | 30.40 | 51.2111 |
| S14 | Aspheric | −7.0466 | 0.4597 | | | 3.0896 |
| S15 | Aspheric | 16.2722 | 1.0060 | 1.67 | 19.00 | −46.7391 |
| S16 | Aspheric | −128.6677 | 0.7639 | | | 99.0000 |
| S17 | Aspheric | −12.2857 | 0.6422 | 1.66 | 20.40 | −2.2830 |
| S18 | Aspheric | −16.7654 | 0.3003 | | | −50.6504 |
| S19 | Aspheric | −5.9047 | 0.4042 | 1.67 | 19.00 | −0.5885 |
| S20 | Aspheric | 8.1437 | 0.1238 | | | −12.1744 |
| S21 | Spherical | Infinite | 0.2100 | 1.52 | 64.20 | |
| S22 | Spherical | Infinite | 0.6000 | | | |
| S23 | Spherical | Infinite | | | | |

TABLE 4

| Surface | | | | | |
|---|---|---|---|---|---|
| number | A4 | A6 | A8 | A10 | A12 |
| S1 | −2.8814E−04 | 4.7782E−05 | −2.7145E−04 | 1.6495E−04 | −5.2318E−05 |
| S2 | −1.3890E−03 | −4.3708E−03 | −7.1655E−03 | 8.8335E−03 | −4.4165E−03 |
| S3 | 9.4474E−03 | −6.8170E−03 | −9.9098E−03 | 1.3018E−02 | −7.1718E−03 |
| S4 | 4.4186E−02 | −2.7471E−02 | 2.0165E−02 | −1.1514E−02 | 4.6578E−03 |
| S5 | −1.5325E−02 | −4.1949E−03 | 9.5640E−03 | −9.9293E−03 | 6.1909E−03 |
| S6 | −4.1372E−02 | 2.1057E−02 | −1.6190E−02 | 9.0726E−03 | −3.9460E−03 |
| S7 | 2.5096E−02 | −2.7685E−03 | −5.8523E−04 | 2.1772E−03 | −2.5150E−03 |
| S8 | −7.1262E−03 | 2.3583E−03 | −1.4812E−03 | 1.8173E−03 | −1.2451E−03 |
| S9 | −2.2378E−02 | 3.1605E−03 | −3.2887E−03 | 3.0223E−03 | −1.6200E−03 |
| S10 | 1.6505E−03 | 2.7707E−03 | −3.0982E−03 | 8.6763E−04 | −1.1668E−04 |
| S11 | 6.5077E−03 | 1.9681E−04 | −2.9780E−03 | 1.5032E−03 | −1.1107E−03 |
| S12 | −9.3185E−03 | −5.1760E−03 | 3.5074E−03 | −2.6855E−03 | 1.3198E−03 |
| S13 | −8.3121E−03 | −7.7232E−03 | 5.7319E−03 | −4.2948E−03 | 2.2997E−03 |
| S14 | −5.4577E−03 | −1.2871E−02 | 9.6476E−03 | −5.1979E−03 | 1.9947E−03 |
| S15 | 5.2062E−03 | −1.3186E−02 | 5.4232E−03 | −1.4939E−03 | 2.5299E−04 |
| S16 | 1.6319E−02 | −1.2194E−02 | 3.7717E−03 | −7.8154E−04 | 1.0616E−04 |
| S17 | 8.4943E−04 | −7.2046E−03 | 1.4783E−03 | −2.1068E−04 | 3.0415E−05 |
| S18 | −1.3857E−03 | 3.0936E−03 | −8.8002E−04 | 1.1216E−04 | −8.0746E−06 |
| S19 | −1.1313E−02 | 9.5549E−03 | −2.1049E−03 | 2.3549E−04 | −1.5202E−05 |
| S20 | −1.1815E−02 | 1.7878E−03 | −2.5131E−04 | 2.1566E−05 | −1.0569E−06 |

| Surface | | | | |
|---|---|---|---|---|
| number | A14 | A16 | A18 | A20 |
| S1 | 9.2650E−06 | −9.0615E−07 | 4.5712E−08 | −9.3247E−10 |
| S2 | 1.2579E−03 | −2.1390E−04 | 2.0373E−05 | −8.3809E−07 |
| S3 | 2.2420E−03 | −4.1231E−04 | 4.1761E−05 | −1.8053E−06 |
| S4 | −1.4098E−03 | 2.9986E−04 | −3.8000E−05 | 2.0895E−06 |
| S5 | −2.3992E−03 | 5.5804E−04 | −7.0846E−05 | 3.7706E−06 |
| S6 | 1.2133E−03 | −2.3307E−04 | 2.4568E−05 | −1.0752E−06 |
| S7 | 1.3232E−03 | −3.5196E−04 | 4.6952E−05 | −2.5116E−06 |
| S8 | 4.9308E−04 | −1.0772E−04 | 1.1894E−05 | −5.1720E−07 |
| S9 | 4.4327E−04 | −4.5278E−05 | −2.5782E−06 | 6.0887E−07 |
| S10 | 8.7751E−06 | −3.7960E−07 | 8.8626E−09 | −8.6750E−11 |
| S11 | 5.8198E−04 | −1.4596E−04 | 1.7013E−05 | −7.5228E−07 |
| S12 | −5.2394E−04 | 1.7845E−04 | −3.4734E−05 | 2.6455E−06 |
| S13 | −9.5596E−04 | 2.7732E−04 | −4.6136E−05 | 3.1538E−06 |
| S14 | −5.3572E−04 | 9.4238E−05 | −9.6748E−06 | 4.3425E−07 |
| S15 | −2.1762E−05 | 4.3402E−09 | 1.4329E−07 | −7.3190E−09 |
| S16 | −8.9810E−06 | 4.5367E−07 | −1.2547E−08 | 1.4652E−10 |
| S17 | −3.1110E−06 | 1.8220E−07 | −5.5212E−09 | 6.7763E−11 |
| S18 | 3.4737E−07 | −8.8397E−09 | 1.2268E−10 | −7.1528E−13 |
| S19 | 5.7650E−07 | −1.1949E−08 | 1.0220E−10 | 8.3707E−14 |
| S20 | 3.1227E−08 | −6.0298E−10 | 7.9776E−12 | −5.6677E−14 |

FIG. 4A shows an a longitudinal aberration curve of a camera lens assembly of Embodiment 2, and the longitudinal aberration curve represents a convergence focus deviation formed when different wavelengths of light pass through the lens. FIG. 4B shows a lateral color curve of a camera lens assembly of Embodiment 2, and the lateral color curve represents a deviation of different image heights on an imaging surface when a light passes through the lens. FIG. 4C shows an astigmatism curve of a camera lens assembly of Embodiment 2, and the astigmatism curve represents tangential image surface curvature and sagittal image surface curvature. FIG. 4D shows a distortion curve of a camera lens assembly of Embodiment 2, and the distortion curve represents distortion values corresponding to different fields of view. It may be seen according to FIG. 4A to FIG. 4D that the camera lens assembly provided in Embodiment 2 can achieve good imaging quality.

### Embodiment 3

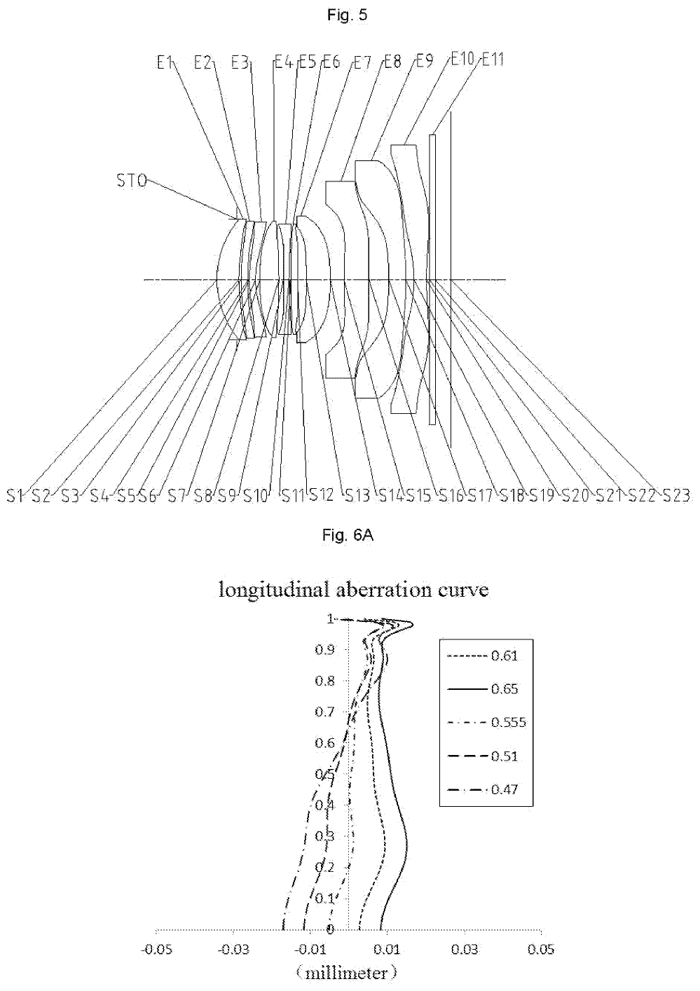

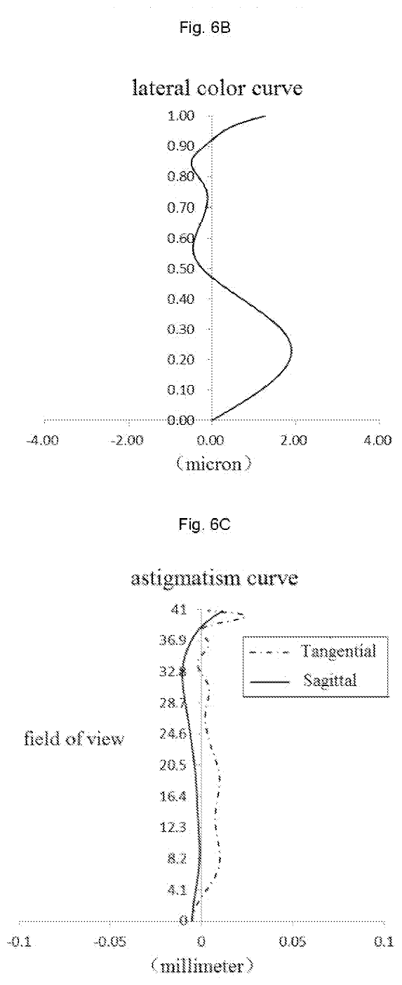

The following describes the camera lens assembly of Embodiment 3 of the disclosure with reference to FIG. 5 to FIG. 6D. FIG. 5 is a schematic structural diagram of a camera lens assembly according to Embodiment 3 of the disclosure.

As shown in FIG. 5, the camera lens assembly includes a diaphragm STO, a first lens E1, a second lens E2, a third lens E3, a fourth lens E4, a fifth lens E5, a sixth lens E6, a seventh lens E7, an eighth lens E8, a ninth lens E9, a tenth lens E10, and a optical filter E11 in sequence from an object side to an image side along an optical axis.

The first lens E1 has a positive refractive power, an object-side surface S1 of the first lens is convex surface, and an image-side surface S2 of the first lens is concave surface. The second lens E2 has a positive refractive power, an object-side surface S3 of the second lens is convex surface, and an image-side surface S4 of the second lens is concave surface. The third lens E3 has a negative refractive power, an object-side surface S5 of the third lens is convex surface, and an image-side surface S6 of the third lens is concave surface. The fourth lens E4 has a positive refractive power, an object-side surface S7 of the fourth lens is convex surface, and an image-side surface S8 of the fourth lens is convex surface. The fifth lens E5 has a negative refractive power, an object-side surface S9 of the fifth lens is convex surface, and an image-side surface S10 of the fifth lens is concave surface. The sixth lens E6 has a negative refractive power, an object-side surface S11 of the sixth lens is convex surface, and an image-side surface S12 of the sixth lens is concave surface. The seventh lens E7 has a positive refractive power, an object-side surface S13 of the seventh lens is concave surface, and an image-side surface S14 of the seventh lens is convex surface. The eighth lens E8 has a positive refractive power, an object-side surface S15 of the eighth lens is convex surface, and an image-side surface S16 of the eighth lens is convex surface. The ninth lens E9 has a negative refractive power, an object-side surface S17 of the ninth lens is concave surface, and an image-side surface S18 of the ninth lens is convex surface. The tenth lens E10 has a negative refractive power, an object-side surface S19 of the tenth lens is concave surface, and an image-side surface S20 of the tenth lens is concave surface. The optical filter E11 has an object-side surface S21 and an image-side surface S22. The camera lens assembly has an imaging surface S23, and a light from an object sequentially passes through the surface S1 to the surface S22 and finally imaged on the imaging surface S23.

In Embodiment 3, a total effective focal length f of the camera lens assembly is 6.91 mm, ImgH is a half of a diagonal length of an effective pixel region on the imaging surface S23, ImgH is 6.09 mm, and FOV is a maximum field of view, FOV is 81.65°.

Table 5 shows basic parameters of the camera lens assembly of Embodiment 3, where both a curvature radius and a thickness/distance are in millimeters (mm). Table 6 shows high-order coefficients that may be used for all aspheric mirror surfaces in Embodiment 3, where each aspheric surface type may be defined by the formula (1) in the Embodiment 1.

TABLE 5

| | | | | Material | | |
|---|---|---|---|---|---|---|
| Surface | Surface | Curvature | Thickness/ | Refractive | Abbe | Conic |
| number | type | radius | distance | index | number | coefficient |
| OBJ | Spherical | Infinite | Infinite | | | |
| STO | Spherical | Infinite | −0.7453 | | | |
| S1 | Aspheric | 3.1942 | 0.8166 | 1.54 | 56.10 | −0.0474 |
| S2 | Aspheric | 5.6033 | 0.0895 | | | −0.1201 |
| S3 | Aspheric | 7.3887 | 0.2643 | 1.56 | 42.80 | 0.4637 |
| S4 | Aspheric | 47.6594 | 0.0500 | | | −5.6371 |
| S5 | Aspheric | 4.6762 | 0.2315 | 1.66 | 20.40 | −0.4092 |
| S6 | Aspheric | 2.8465 | 0.1601 | | | −0.1375 |
| S7 | Aspheric | 11.0213 | 0.7127 | 1.54 | 56.10 | −80.9496 |
| S8 | Aspheric | −22.7686 | 0.1752 | | | 82.4907 |
| S9 | Aspheric | 18.3307 | 0.2100 | 1.64 | 23.80 | −41.4406 |
| S10 | Aspheric | 14.7782 | 0.0587 | | | −73.5409 |
| S11 | Aspheric | 20.7590 | 0.2590 | 1.66 | 20.40 | 99.0000 |
| S12 | Aspheric | 20.5676 | 0.3321 | | | −0.3107 |
| S13 | Aspheric | −23.4559 | 0.9000 | 1.58 | 33.70 | 99.0000 |
| S14 | Aspheric | −7.2915 | 0.5118 | | | −7.0047 |
| S15 | Aspheric | 16.5325 | 0.9357 | 1.67 | 19.00 | −12.9285 |
| S16 | Aspheric | −57.1248 | 0.7478 | | | 99.0000 |
| S17 | Aspheric | −10.9355 | 0.6443 | 1.66 | 20.40 | −3.5126 |
| S18 | Aspheric | −13.4457 | 0.3013 | | | 8.3967 |
| S19 | Aspheric | −5.4195 | 0.4684 | 1.67 | 19.00 | −0.3685 |
| S20 | Aspheric | 8.5287 | 0.1170 | | | −63.1147 |
| S21 | Spherical | Infinite | 0.2100 | 1.52 | 64.20 | |
| S22 | Spherical | Infinite | 0.6000 | | | |
| S23 | Spherical | Infinite | | | | |

TABLE 6

| Surface | | | | | |
|---|---|---|---|---|---|
| number | A4 | A6 | A8 | A10 | A12 |
| S1 | −3.4616E−04 | −3.1919E−04 | 3.5947E−04 | −3.7412E−04 | 2.1471E−04 |
| S2 | −2.6718E−03 | −3.4577E−03 | −9.4176E−03 | 1.0786E−02 | −5.1995E−03 |
| S3 | 1.1333E−02 | −6.4843E−03 | −1.4009E−02 | 1.7032E−02 | −9.0673E−03 |
| S4 | 4.7884E−02 | −3.1166E−02 | 2.2250E−02 | −1.2699E−02 | 5.4483E−03 |
| S5 | −1.9400E−02 | −3.5156E−03 | 9.7692E−03 | −9.2086E−03 | 5.5127E−03 |
| S6 | −4.3798E−02 | 2.3713E−02 | −1.8271E−02 | 1.0282E−02 | −4.0999E−03 |
| S7 | 2.5645E−02 | −1.5659E−03 | −1.6797E−03 | 9.2026E−04 | −5.6276E−04 |
| S8 | −2.2315E−03 | −6.6499E−04 | 1.2002E−03 | −1.0540E−03 | 4.9121E−04 |
| S9 | −2.2008E−02 | 4.5510E−03 | −3.7492E−03 | 1.3051E−03 | 2.6097E−05 |
| S10 | −2.9019E−03 | 9.1401E−03 | −7.5982E−03 | 2.8170E−03 | −6.1054E−04 |
| S11 | −1.9822E−03 | 3.8109E−03 | −5.6603E−03 | 3.9116E−03 | −2.3079E−03 |
| S12 | −1.0011E−02 | −5.3283E−03 | 3.0773E−03 | −1.9103E−03 | 9.9743E−04 |
| S13 | −5.1215E−03 | −7.3412E−03 | 4.7855E−03 | −3.8057E−03 | 2.2297E−03 |
| S14 | −7.3162E−03 | −1.1550E−02 | 7.8812E−03 | −4.1028E−03 | 1.5548E−03 |
| S15 | 6.3091E−03 | −1.2940E−02 | 4.5955E−03 | −1.0829E−03 | 1.3044E−04 |
| S16 | 1.8912E−02 | −1.3265E−02 | 3.7586E−03 | −7.3663E−04 | 9.8932E−05 |
| S17 | 1.2736E−03 | −6.0302E−03 | 6.9713E−04 | −8.0391E−06 | 1.4021E−06 |
| S18 | −8.2382E−03 | 6.5083E−03 | −1.5751E−03 | 2.0385E−04 | −1.5844E−05 |
| S19 | −2.3785E−02 | 1.5546E−02 | −3.5643E−03 | 4.6140E−04 | −3.7296E−05 |
| S20 | −5.5427E−03 | 8.4031E−04 | −1.7045E−04 | 1.8341E−05 | −1.0459E−06 |

| Surface | | | | |
|---|---|---|---|---|
| number | A14 | A16 | A18 | A20 |
| S1 | −6.9005E−05 | 1.2322E−05 | −1.1260E−06 | 4.0715E−08 |
| S2 | 1.4087E−03 | −2.2273E−04 | 1.9329E−05 | −7.1763E−07 |
| S3 | 2.7427E−03 | −4.8335E−04 | 4.6267E−05 | −1.8659E−06 |
| S4 | −1.8919E−03 | 4.7521E−04 | −6.9483E−05 | 4.2564E−06 |
| S5 | −2.2461E−03 | 5.7642E−04 | −8.1523E−05 | 4.7916E−06 |
| S6 | 1.0400E−03 | −1.4447E−04 | 8.0204E−06 | 4.3887E−08 |
| S7 | 2.6897E−04 | −6.5186E−05 | 7.5562E−06 | −3.4029E−07 |
| S8 | −8.8836E−05 | 1.9564E−06 | 1.0112E−06 | −7.5923E−08 |
| S9 | −2.0055E−04 | 8.4008E−05 | −1.6112E−05 | 1.2245E−06 |
| S10 | 9.1719E−05 | −1.0226E−05 | 7.5399E−07 | −2.5731E−08 |
| S11 | 9.1329E−04 | −1.9820E−04 | 2.1432E−05 | −9.0845E−07 |
| S12 | −4.6173E−04 | 1.6416E−04 | −3.0995E−05 | 2.2620E−06 |
| S13 | −9.7127E−04 | 2.7936E−04 | −4.4681E−05 | 2.9177E−06 |
| S14 | −4.1811E−04 | 7.4313E−05 | −7.7400E−06 | 3.5219E−07 |
| S15 | 3.2653E−06 | −3.2476E−06 | 3.7814E−07 | −1.4400E−08 |
| S16 | −8.4201E−06 | 4.2950E−07 | −1.2030E−08 | 1.4311E−10 |
| S17 | −5.8499E−07 | 4.9011E−08 | −1.6386E−09 | 1.9945E−11 |
| S18 | 7.5347E−07 | −2.1331E−08 | 3.2892E−10 | −2.1223E−12 |
| S19 | 1.9217E−06 | −6.1365E−08 | 1.1059E−09 | −8.5855E−12 |
| S20 | 3.3877E−08 | −6.2793E−10 | 6.2135E−12 | −2.5476E−14 |

FIG. 6A shows an a longitudinal aberration curve of a camera lens assembly of Embodiment 3, and the longitudinal aberration curve represents a convergence focus deviation formed when different wavelengths of light pass through the lens. FIG. 6B shows a lateral color curve of a camera lens assembly of Embodiment 3, and the lateral color curve represents a deviation of different image heights on an imaging surface when a light passes through the lens. FIG. 6C shows an astigmatism curve of a camera lens assembly of Embodiment 3, and the astigmatism curve represents tangential image surface curvature and sagittal image surface curvature. FIG. 6D shows a distortion curve of a camera lens assembly of Embodiment 3, and the distortion curve represents distortion values corresponding to different fields of view. It may be seen according to FIG. 6A to FIG. 6D that the camera lens assembly provided in Embodiment 3 can achieve good imaging quality.

### Embodiment 4

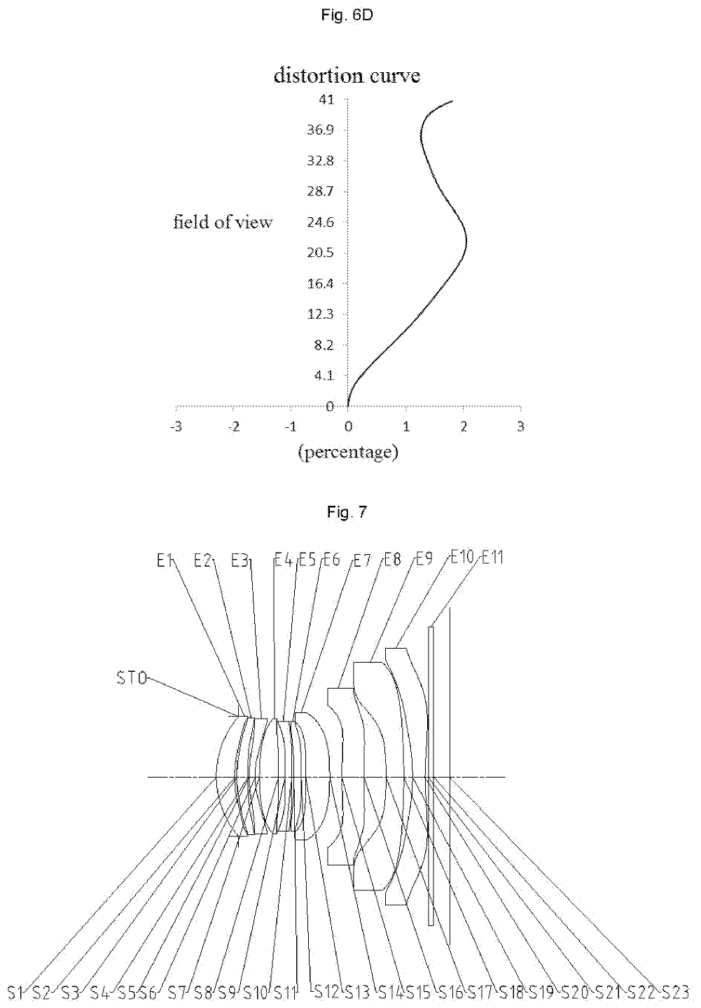

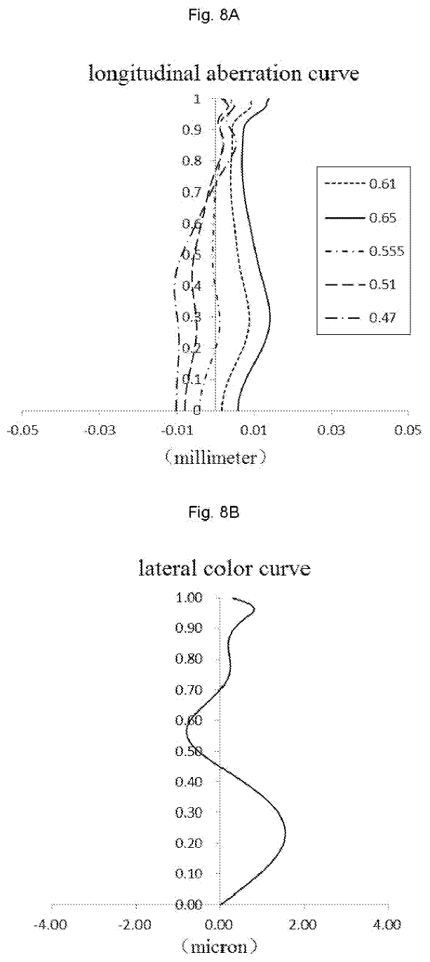

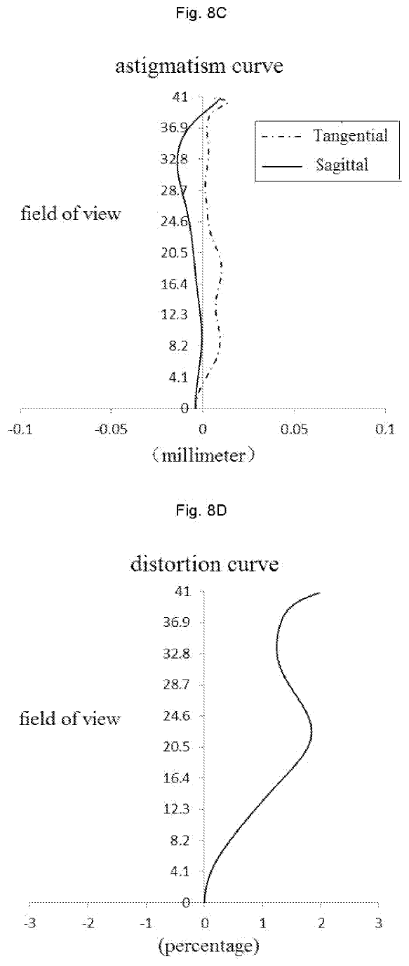

The following describes the camera lens assembly of Embodiment 4 of the disclosure with reference to FIG. 7 to FIG. 8D. FIG. 7 is a schematic structural diagram of a camera lens assembly according to Embodiment 4 of the disclosure.

As shown in FIG. 7, the camera lens assembly includes a diaphragm STO, a first lens E1, a second lens E2, a third lens E3, a fourth lens E4, a fifth lens E5, a sixth lens E6, a seventh lens E7, an eighth lens E8, a ninth lens E9, a tenth lens E10, and a optical filter E11 in sequence from an object side to an image side along an optical axis.

The first lens E1 has a positive refractive power, an object-side surface S1 of the first lens is convex surface, and an image-side surface S2 of the first lens is concave surface. The second lens E2 has a positive refractive power, an object-side surface S3 of the second lens is convex surface, and an image-side surface S4 of the second lens is concave surface. The third lens E3 has a negative refractive power, an object-side surface S5 of the third lens is convex surface, and an image-side surface S6 of the third lens is concave surface. The fourth lens E4 has a positive refractive power, an object-side surface S7 of the fourth lens is convex surface, and an image-side surface S8 of the fourth lens is convex surface. The fifth lens E5 has a positive refractive power, an object-side surface S9 of the fifth lens is convex surface, and an image-side surface S10 of the fifth lens is convex surface. The sixth lens E6 has a negative refractive power, an object-side surface S11 of the sixth lens is concave surface, and an image-side surface S12 of the sixth lens is convex surface. The seventh lens E7 has a positive refractive power, an object-side surface S13 of the seventh lens is concave surface, and an image-side surface S14 of the seventh lens is convex surface. The eighth lens E8 has a positive refractive power, an object-side surface S15 of the eighth lens is convex surface, and an image-side surface S16 of the eighth lens is concave surface. The ninth lens E9 has a negative refractive power, an object-side surface S17 of the ninth lens is concave surface, and an image-side surface S18 of the ninth lens is convex surface. The tenth lens E10 has a negative refractive power, an object-side surface S19 of the tenth lens is concave surface, and an image-side surface S20 of the tenth lens is concave surface. The optical filter E11 has an object-side surface S21 and an image-side surface S22. The camera lens assembly has an imaging surface S23, and a light from an object sequentially passes through the surface S1 to the surface S22 and finally imaged on the imaging surface S23.

In Embodiment 4, a total effective focal length f of the camera lens assembly is 6.95 mm, ImgH is a half of a diagonal length of an effective pixel region on the imaging surface S23, ImgH is 6.13 mm, and FOV is a maximum field of view, FOV is 81.65°.

Table 7 shows basic parameters of the camera lens assembly of Embodiment 4, where both a curvature radius and a thickness/distance are in millimeters (mm). Table 8 shows high-order coefficients that may be used for all aspheric mirror surfaces in Embodiment 4, where each aspheric surface type may be defined by the formula (1) in the Embodiment 1.

TABLE 7

| | | | | Material | | |
|---|---|---|---|---|---|---|
| Surface | Surface | Curvature | Thickness/ | Refractive | Abbe | Conic |
| number | type | radius | distance | index | number | coefficient |
| OBJ | Spherical | Infinite | Infinite | | | |
| STO | Spherical | Infinite | −0.8145 | | | |
| S1 | Aspheric | 3.1191 | 0.6955 | 1.54 | 56.10 | −0.0482 |
| S2 | Aspheric | 3.8970 | 0.0782 | | | −0.2664 |
| S3 | Aspheric | 4.5770 | 0.4148 | 1.55 | 49.20 | 0.6373 |
| S4 | Aspheric | 27.7155 | 0.0500 | | | −99.0000 |
| S5 | Aspheric | 4.3641 | 0.2220 | 1.66 | 20.40 | −0.6150 |
| S6 | Aspheric | 2.7079 | 0.1597 | | | −0.1417 |
| S7 | Aspheric | 8.8626 | 0.7209 | 1.54 | 56.10 | −65.5301 |
| S8 | Aspheric | −37.5621 | 0.2460 | | | −97.6902 |
| S9 | Aspheric | 75.0699 | 0.2531 | 1.64 | 23.80 | −99.0000 |
| S10 | Aspheric | −69.0248 | 0.0855 | | | 99.0000 |
| S11 | Aspheric | −11.0459 | 0.2787 | 1.66 | 20.40 | −99.0000 |
| S12 | Aspheric | −24.8568 | 0.1641 | | | 99.0000 |
| S13 | Aspheric | −83.6326 | 0.9000 | 1.59 | 31.70 | 99.0000 |
| S14 | Aspheric | −8.9808 | 0.4528 | | | −3.2264 |
| S15 | Aspheric | 10.7991 | 0.8394 | 1.67 | 19.00 | −89.9576 |
| S16 | Aspheric | 49.9000 | 0.8300 | | | −99.0000 |
| S17 | Aspheric | −10.7662 | 0.6667 | 1.66 | 20.40 | −99.0000 |
| S18 | Aspheric | −13.1881 | 0.3360 | | | 8.5266 |
| S19 | Aspheric | −6.1297 | 0.4577 | 1.67 | 19.00 | −0.1640 |
| S20 | Aspheric | 7.2406 | 0.1275 | | | −49.1363 |
| S21 | Spherical | Infinite | 0.2100 | 1.52 | 54.20 | |
| S22 | Spherical | Infinite | 0.6000 | | | |
| S23 | Spherical | Infinite | | | | |

TABLE 8

| Surface | | | | | |
|---|---|---|---|---|---|
| number | A4 | A6 | A8 | A10 | A12 |
| S1 | −7.7319E−04 | −6.6826E−04 | 8.0614E−04 | −7.4707E−04 | 4.0222E−04 |
| S2 | −4.6055E−03 | −1.2326E−03 | −3.0502E−03 | 1.5861E−03 | 4.3971E−06 |
| S3 | 1.4448E−04 | −1.1656E−04 | −4.6025E−03 | 2.5709E−03 | −1.7329E−04 |
| S4 | 4.2757E−02 | −3.3474E−02 | 3.0069E−02 | −2.1265E−02 | 1.1280E−02 |
| S5 | −1.0909E−02 | −1.2384E−02 | 1.1679E−02 | −7.9789E−03 | 4.4698E−03 |
| S6 | −4.1021E−02 | 2.1508E−02 | −2.1153E−02 | 1.5940E−02 | −8.4128E−03 |
| S7 | 2.2192E−02 | 3.0730E−04 | −3.6694E−03 | 4.2051E−03 | −3.1667E−03 |
| S8 | −4.7121E−03 | −1.8432E−03 | 2.9977E−03 | −2.0687E−03 | 8.3307E−04 |
| S9 | −1.9229E−02 | −9.6229E−03 | 1.1886E−02 | −8.0098E−03 | 3.7732E−03 |
| S10 | 1.2398E−02 | −4.0410E−02 | 4.1481E−02 | −2.4332E−02 | 8.6042E−03 |
| S11 | 2.5457E−02 | −5.4977E−02 | 5.4929E−02 | −3.3102E−02 | 1.1719E−02 |
| S12 | 1.2143E−02 | −4.2353E−02 | 3.9551E−02 | −2.3600E−02 | 8.5564E−03 |
| S13 | −1.8623E−03 | −2.0434E−02 | 1.5249E−02 | −6.7687E−03 | 1.1808E−03 |
| S14 | −6.3371E−03 | −1.2245E−02 | 8.3587E−03 | −3.8282E−03 | 1.2129E−03 |
| S15 | 1.1027E−02 | −1.6728E−02 | 6.6910E−03 | −1.9446E−03 | 3.8725E−04 |
| S16 | 1.3003E−02 | −1.2048E−02 | 3.5634E−03 | −7.3233E−04 | 1.0479E−04 |
| S17 | −9.0297E−03 | −4.4277E−03 | 2.4214E−04 | 1.2489E−04 | −1.9475E−05 |
| S18 | 1.4217E−02 | −3.8494E−03 | 5.4503E−04 | −4.5395E−05 | 2.2984E−06 |
| S19 | −2.7075E−03 | 5.6115E−03 | −1.5686E−03 | 2.2618E−04 | −1.9766E−05 |
| S20 | −6.4249E−03 | 6.8212E−04 | −9.8221E−05 | 7.8250E−06 | −3.2931E−07 |

| Surface | | | | |
|---|---|---|---|---|
| number | A14 | A16 | A18 | A20 |
| S1 | −1.2821E−04 | 2.3648E−05 | −2.2821E−06 | 8.8028E−08 |
| S2 | −2.2079E−04 | 7.8544E−05 | −1.1538E−05 | 6.2886E−07 |
| S3 | −3.5416E−04 | 1.5375E−04 | −2.5825E−05 | 1.5834E−06 |
| S4 | −4.2679E−03 | 1.0306E−03 | −1.3826E−04 | 7.7578E−06 |
| S5 | −1.8406E−03 | 4.7801E−04 | −6.7558E−05 | 3.9291E−06 |
| S6 | 2.9139E−03 | −6.2513E−04 | 7.5485E−05 | −3.9441E−06 |
| S7 | 1.4176E−03 | −3.6102E−04 | 4.9105E−05 | −2.7799E−06 |
| S8 | −1.7639E−04 | 1.8628E−05 | −8.3899E−07 | 7.8002E−09 |
| S9 | −1.2904E−03 | 2.9710E−04 | −3.9995E−05 | 2.3543E−06 |
| S10 | −1.8443E−03 | 2.3413E−04 | −1.6173E−05 | 4.6751E−07 |
| S11 | −2.3521E−03 | 2.5119E−04 | −1.1862E−05 | 1.0733E−07 |
| S12 | −1.8263E−03 | 2.2470E−04 | −1.4873E−05 | 4.2926E−07 |
| S13 | 1.8396E−04 | −1.1444E−04 | 1.7575E−05 | −9.3562E−07 |
| S14 | −2.7317E−04 | 4.1987E−05 | −3.9675E−06 | 1.7129E−07 |
| S15 | −4.9140E−05 | 3.4529E−06 | −9.6305E−08 | −3.4386E−10 |
| S16 | −9.5531E−06 | 5.2319E−07 | −1.5720E−08 | 1.9957E−10 |
| S17 | 1.2314E−06 | −4.0086E−08 | 6.6598E−10 | −4.4847E−12 |
| S18 | −7.1386E−08 | 1.3243E−09 | −1.3432E−11 | 5.7222E−14 |
| S19 | 1.0813E−06 | −3.6054E−08 | 6.6708E−10 | −5.2321E−12 |
| S20 | 7.9720E−09 | −1.1634E−10 | 1.0193E−12 | −4.3912E−15 |

FIG. 8A shows an a longitudinal aberration curve of a camera lens assembly of Embodiment 4, and the longitudinal aberration curve represents a convergence focus deviation formed when different wavelengths of light pass through the lens. FIG. 8B shows a lateral color curve of a camera lens assembly of Embodiment 4, and the lateral color curve represents a deviation of different image heights on an imaging surface when a light passes through the lens. FIG. 8C shows an astigmatism curve of a camera lens assembly of Embodiment 4, and the astigmatism curve represents tangential image surface curvature and sagittal image surface curvature. FIG. 8D shows a distortion curve of a camera lens assembly of Embodiment 4, and the distortion curve represents distortion values corresponding to different fields of view. It may be seen according to FIG. 8A to FIG. 8D that the camera lens assembly provided in Embodiment 4 can achieve good imaging quality.

### Embodiment 5

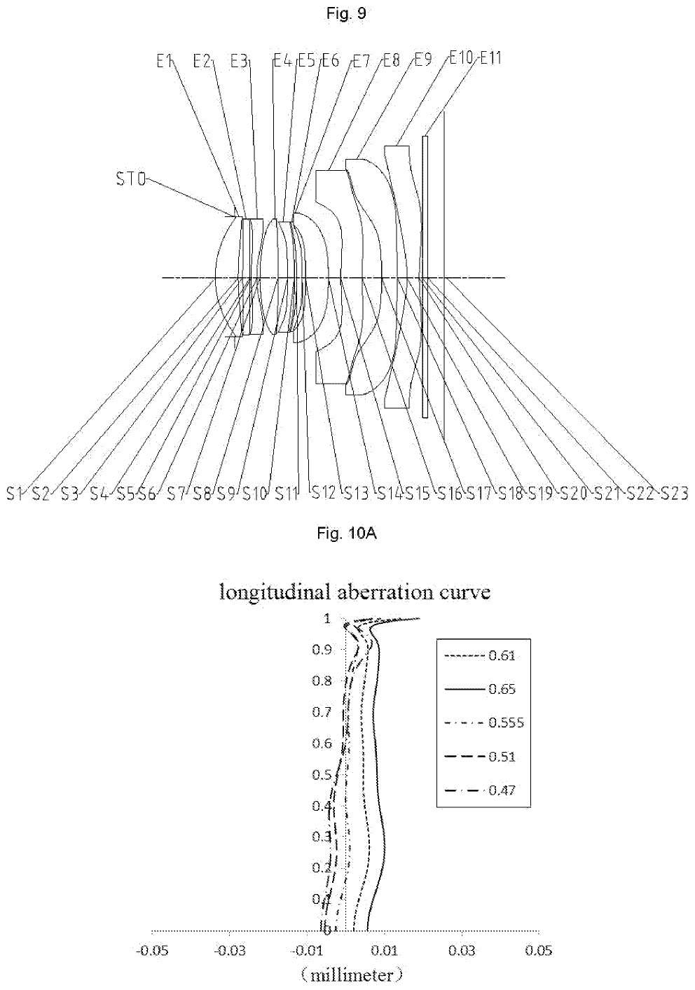

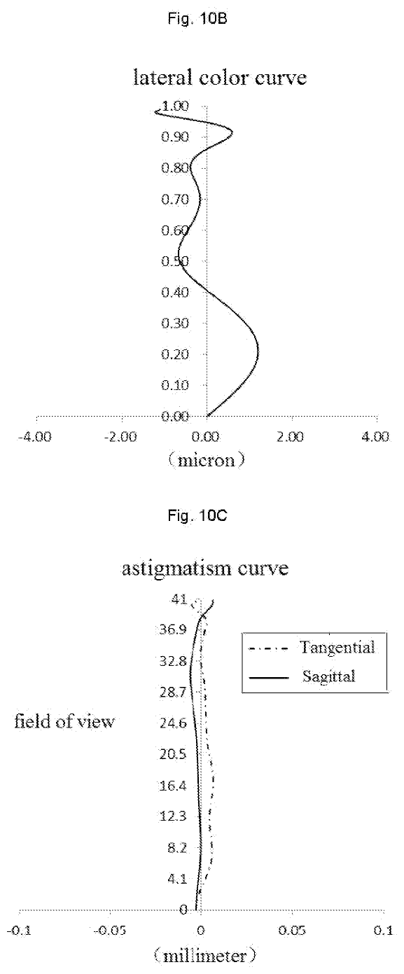

The following describes the camera lens assembly of Embodiment 5 of the disclosure with reference to FIG. 9 to FIG. 10D. FIG. 9 is a schematic structural diagram of a camera lens assembly according to Embodiment 5 of the disclosure.

As shown in FIG. 9, the camera lens assembly includes a diaphragm STO, a first lens E1, a second lens E2, a third lens E3, a fourth lens E4, a fifth lens E5, a sixth lens E6, a seventh lens E7, an eighth lens E8, a ninth lens E9, a tenth lens E10, and a optical filter E11 in sequence from an object side to an image side along an optical axis.

The first lens E1 has a positive refractive power, an object-side surface S1 of the first lens is convex surface, and an image-side surface S2 of the first lens is concave surface. The second lens E2 has a positive refractive power, an object-side surface S3 of the second lens is convex surface, and an image-side surface S4 of the second lens is convex surface. The third lens E3 has a negative refractive power, an object-side surface S5 of the third lens is convex surface, and an image-side surface S6 of the third lens is concave surface. The fourth lens E4 has a positive refractive power, an object-side surface S7 of the fourth lens is convex surface, and an image-side surface S8 of the fourth lens is convex surface. The fifth lens E5 has a positive refractive power, an object-side surface S9 of the fifth lens is concave surface, and an image-side surface S10 of the fifth lens is convex surface. The sixth lens E6 has a negative refractive power, an object-side surface S11 of the sixth lens is concave surface, and an image-side surface S12 of the sixth lens is convex surface. The seventh lens E7 has a positive refractive power, an object-side surface S13 of the seventh lens is convex surface, and an image-side surface S14 of the seventh lens is convex surface. The eighth lens E8 has a positive refractive power, an object-side surface S15 of the eighth lens is convex surface, and an image-side surface S16 of the eighth lens is concave surface. The ninth lens E9 has a negative refractive power, an object-side surface S17 of the ninth lens is concave surface, and an image-side surface S18 of the ninth lens is convex surface. The tenth lens E10 has a negative refractive power, an object-side surface S19 of the tenth lens is concave surface, and an image-side surface S20 of the tenth lens is concave surface. The optical filter E11 has an object-side surface S21 and an image-side surface S22. The camera lens assembly has an imaging surface S23, and a light from an object sequentially passes through the surface S1 to the surface S22 and finally imaged on the imaging surface S23.

In Embodiment 5, a total effective focal length f of the camera lens assembly is 6.82 mm, ImgH is a half of a diagonal length of an effective pixel region on the imaging surface S23, ImgH is 6.01 mm, and FOV is a maximum field of view, FOV is 81.65°.

Table 9 shows basic parameters of the camera lens assembly of Embodiment 5, where both a curvature radius and a thickness/distance are in millimeters (mm). Table 10 shows high-order coefficients that may be used for all aspheric mirror surfaces in Embodiment 5, where each aspheric surface type may be defined by the formula (1) in the Embodiment 1.

TABLE 9

| | | | | Material | | |
|---|---|---|---|---|---|---|
| Surface | Surface | Curvature | Thickness/ | Refractive | Abbe | Conic |
| number | type | radius | distance | index | number | coefficient |
| OBJ | Spherical | Infinite | Infinite | | | |
| STO | Spherical | Infinite | −0.7202 | | | |
| S1 | Aspheric | 3.2130 | 0.8568 | 1.54 | 56.09 | −0.2684 |
| S2 | Aspheric | 7.7080 | 0.1684 | | | −1.0890 |
| S3 | Aspheric | 17.5099 | 0.2778 | 1.59 | 32.30 | 2.5489 |
| S4 | Aspheric | −23.3491 | 0.0500 | | | 95.6443 |
| S5 | Aspheric | 7.2306 | 0.2100 | 1.66 | 20.37 | −1.7331 |
| S6 | Aspheric | 3.2628 | 0.1191 | | | −0.2200 |
| S7 | Aspheric | 7.4885 | 0.6746 | 1.54 | 56.09 | −77.2846 |
| S8 | Aspheric | −92.0042 | 0.3683 | | | 99.0000 |
| S9 | Aspheric | −80.8504 | 0.2510 | 1.64 | 23.80 | 99.0000 |
| S10 | Aspheric | −38.5677 | 0.0879 | | | −99.0000 |
| S11 | Aspheric | −10.2169 | 0.2100 | 1.66 | 20.40 | −37.2053 |
| S12 | Aspheric | −19.7503 | 0.1215 | | | 87.8168 |
| S13 | Aspheric | 179.7054 | 0.8692 | 1.59 | 30.00 | −99.0000 |
| S14 | Aspheric | −9.2239 | 0.4576 | | | 14.6487 |
| S15 | Aspheric | 9.8997 | 0.8153 | 1.67 | 19.00 | −38.6120 |
| S16 | Aspheric | 38.2915 | 0.7264 | | | −99.0000 |
| S17 | Aspheric | −13.4700 | 0.5985 | 1.66 | 20.40 | −98.9280 |
| S18 | Aspheric | −14.5098 | 0.3591 | | | 10.4991 |
| S19 | Aspheric | −5.0720 | 0.4530 | 1.67 | 19.00 | −6.1289 |
| S20 | Aspheric | 7.4426 | 0.1231 | | | −25.5972 |
| S21 | Spherical | Infinite | 0.2100 | 1.52 | 54.20 | |
| S22 | Spherical | Infinite | 0.6000 | | | |
| S23 | Spherical | Infinite | | | | |

TABLE 10

| Surface | | | | | |
|---|---|---|---|---|---|
| number | A4 | A6 | A8 | A10 | A12 |
| S1 | 2.9647E−04 | −1.9086E−04 | 1.4092E−04 | −1.3125E−04 | 6.3339E−05 |
| S2 | −6.7855E−03 | −4.2186E−04 | −6.6900E−04 | 5.8138E−04 | −2.7543E−04 |
| S3 | −9.9419E−03 | 3.0703E−03 | −3.7357E−03 | 2.1485E−03 | −6.6813E−04 |
| S4 | 3.0921E−02 | −2.3299E−02 | 1.4430E−02 | −7.9752E−03 | 3.4742E−03 |
| S5 | −1.1877E−02 | −8.3274E−03 | 4.4672E−03 | −7.4458E−04 | −3.2356E−04 |
| S6 | −3.7581E−02 | 1.5364E−02 | −1.5714E−02 | 1.2363E−02 | −6.9692E−03 |
| S7 | 3.5527E−02 | −1.5906E−02 | 5.8007E−03 | −1.2048E−03 | −6.6501E−04 |
| S8 | −2.4907E−03 | −1.3552E−03 | 7.2007E−04 | −1.4016E−04 | −6.3248E−06 |
| S9 | −1.6293E−02 | −1.0072E−02 | 5.9130E−03 | −1.2803E−03 | −7.3753E−04 |
| S10 | 1.1461E−02 | −3.3010E−02 | 2.2454E−02 | −8.1288E−03 | 1.2421E−03 |
| S11 | 2.2545E−02 | −4.3280E−02 | 3.2806E−02 | −1.4876E−02 | 3.8427E−03 |
| S12 | −7.7144E−03 | −3.4866E−02 | 3.9009E−02 | −2.6196E−02 | 1.1631E−02 |
| S13 | −2.3758E−02 | −1.8438E−02 | 2.0154E−02 | −1.1700E−02 | 3.8204E−03 |
| S14 | −1.0992E−02 | −1.1386E−02 | 8.7627E−03 | −3.8538E−03 | 1.1296E−03 |
| S15 | 3.4809E−03 | −1.4708E−02 | 6.0141E−03 | −1.3873E−03 | 1.5439E−04 |
| S16 | 1.2084E−02 | −1.3579E−02 | 4.5492E−03 | −8.7872E−04 | 1.0104E−04 |
| S17 | −7.3092E−03 | −6.0542E−03 | 1.1233E−03 | −4.8498E−05 | −2.8300E−06 |
| S18 | 1.2983E−02 | −2.5585E−03 | 2.4502E−04 | −1.4267E−05 | 5.0474E−07 |
| S19 | −1.7479E−03 | 3.3951E−03 | −8.7802E−04 | 10942E−04 | −7.8684E−06 |
| S20 | −1.0079E−02 | 1.4277E−03 | −2.5249E−04 | 2.8055E−05 | −1.7220E−06 |

| Surface | | | | |
|---|---|---|---|---|
| number | A14 | A16 | A18 | A20 |
| S1 | −1.7849E−05 | 2.7196E−06 | −2.0400E−07 | 5.8981E−09 |
| S2 | 9.8146E−05 | −2.2765E−05 | 2.9110E−06 | −1.5194E−07 |
| S3 | 1.4125E−04 | −2.3273E−05 | 2.7050E−06 | −1.4566E−07 |
| S4 | −1.0412E−03 | 1.9372E−04 | −1.9802E−05 | 8.4246E−07 |
| S5 | 1.8497E−04 | −3.5174E−05 | 2.8346E−06 | −8.0575E−08 |
| S6 | 2.5539E−03 | −5.5667E−04 | 6.4918E−05 | −3.1163E−06 |
| S7 | 6.3909E−04 | −1.9755E−04 | 2.7196E−05 | −1.4076E−06 |
| S8 | 1.5944E−05 | −4.0785E−06 | 4.0880E−07 | −1.4598E−08 |
| S9 | 6.8358E−04 | −2.3549E−04 | 4.0736E−05 | −2.9027E−06 |
| S10 | 1.2277E−04 | −7.3807E−05 | 9.8920E−06 | −4.5209E−07 |
| S11 | −4.8941E−04 | 1.5224E−05 | 2.4331E−06 | −1.7711E−07 |
| S12 | −3.4730E−03 | 6.8554E−04 | −8.0943E−05 | 4.3500E−06 |
| S13 | −6.0543E−04 | −6.8468E−06 | 1.6401E−05 | −1.7310E−06 |
| S14 | −2.3217E−04 | 3.1722E−05 | −2.5514E−06 | 8.8241E−08 |
| S15 | 8.1073E−07 | −2.7222E−06 | 3.2517E−07 | −1.2511E−08 |
| S16 | −6.6650E−06 | 2.3086E−07 | −3.2238E−09 | −90351E−13 |
| S17 | 3.5231E−07 | −1.3912E−08 | 2.5306E−10 | −1.7967E−12 |
| S18 | −1.0872E−08 | 1.3934E−10 | −9.7690E−13 | 2.8843E−15 |
| S19 | 3.4485E−07 | −9.1322E−09 | 1.3446E−10 | −8.4475E−13 |
| S20 | 6.0793E−08 | −1.2389E−09 | 1.3607E−11 | −6.2569E−14 |

FIG. 10A shows an a longitudinal aberration curve of a camera lens assembly of Embodiment 5, and the longitudinal aberration curve represents a convergence focus deviation formed when different wavelengths of light pass through the lens. FIG. 10B shows a lateral color curve of a camera lens assembly of Embodiment 5, and the lateral color curve represents a deviation of different image heights on an imaging surface when a light passes through the lens. FIG. 10C shows an astigmatism curve of a camera lens assembly of Embodiment 5, and the astigmatism curve represents tangential image surface curvature and sagittal image surface curvature. FIG. 10D shows a distortion curve of a camera lens assembly of Embodiment 5, and the distortion curve represents distortion values corresponding to different fields of view. It may be seen according to FIG. 10A to FIG. 10D that the camera lens assembly provided in Embodiment 5 can achieve good imaging quality.

### Embodiment 6

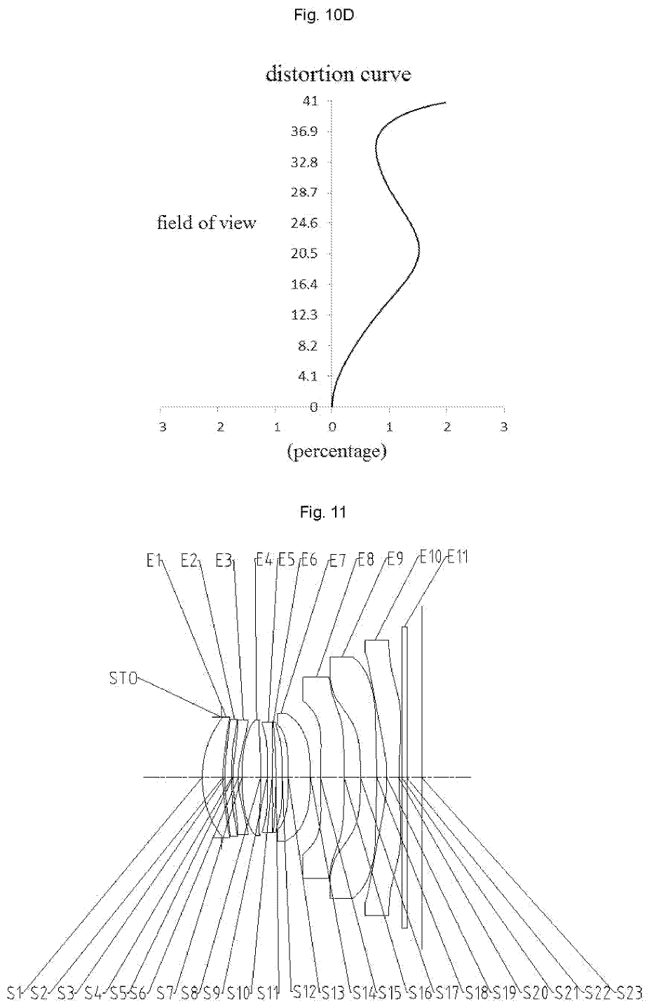

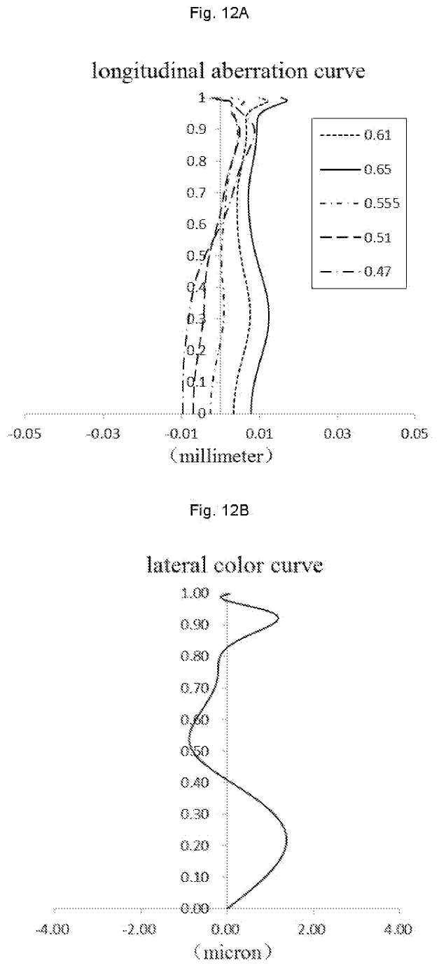

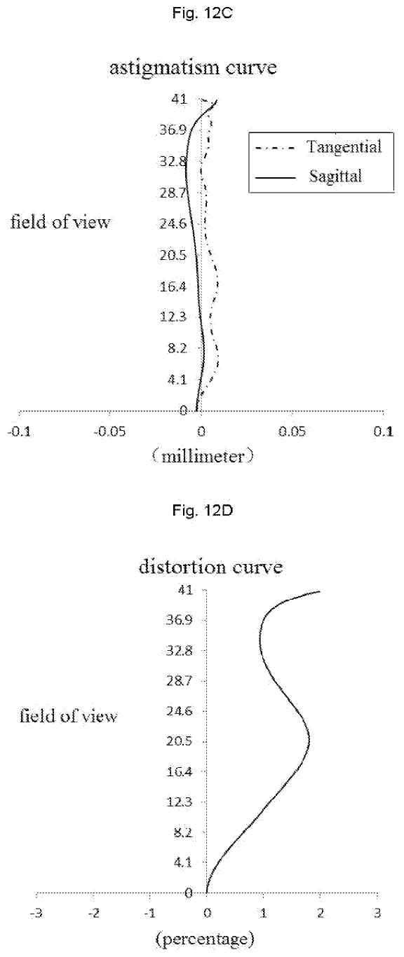

The following describes the camera lens assembly of Embodiment 6 of the disclosure with reference to FIG. 11 to FIG. 12D. FIG. 11 is a schematic structural diagram of a camera lens assembly according to Embodiment 6 of the disclosure.

As shown in FIG. 11, the camera lens assembly includes a diaphragm STO, a first lens E1, a second lens E2, a third lens E3, a fourth lens E4, a fifth lens E5, a sixth lens E6, a seventh lens E7, an eighth lens E8, a ninth lens E9, a tenth lens E10, and a optical filter E11 in sequence from an object side to an image side along an optical axis.

The first lens E1 has a positive refractive power, an object-side surface S1 of the first lens is convex surface, and an image-side surface S2 of the first lens is concave surface. The second lens E2 has a positive refractive power, an object-side surface S3 of the second lens is convex surface, and an image-side surface S4 of the second lens is concave surface. The third lens E3 has a negative refractive power, an object-side surface S5 of the third lens is convex surface, and an image-side surface S6 of the third lens is concave surface. The fourth lens E4 has a positive refractive power, an object-side surface S7 of the fourth lens is convex surface, and an image-side surface S8 of the fourth lens is convex surface. The fifth lens E5 has a negative refractive power, an object-side surface S9 of the fifth lens is convex surface, and an image-side surface S10 of the fifth lens is concave surface. The sixth lens E6 has a negative refractive power, an object-side surface S11 of the sixth lens is concave surface, and an image-side surface S12 of the sixth lens is convex surface. The seventh lens E7 has a positive refractive power, an object-side surface S13 of the seventh lens is concave surface, and an image-side surface S14 of the seventh lens is convex surface. The eighth lens E8 has a positive refractive power, an object-side surface S15 of the eighth lens is convex surface, and an image-side surface S16 of the eighth lens is convex surface. The ninth lens E9 has a negative refractive power, an object-side surface S17 of the ninth lens is concave surface, and an image-side surface S18 of the ninth lens is convex surface. The tenth lens E10 has a negative refractive power, an object-side surface S19 of the tenth lens is concave surface, and an image-side surface S20 of the tenth lens is concave surface. The optical filter E11 has an object-side surface S21 and an image-side surface S22. The camera lens assembly has an imaging surface S23, and a light from an object sequentially passes through the surface S1 to the surface S22 and finally imaged on the imaging surface S23.

In Embodiment 6, a total effective focal length f of the camera lens assembly is 7.03 mm, ImgH is a half of a diagonal length of an effective pixel region on the imaging surface S23, ImgH is 6.20 mm, and FOV is a maximum field of view, FOV is 81.65°.

Table 11 shows basic parameters of the camera lens assembly of Embodiment 6, where both a curvature radius and a thickness/distance are in millimeters (mm). Table 12 shows high-order coefficients that may be used for all aspheric mirror surfaces in Embodiment 6, where each aspheric surface type may be defined by the formula (1) in the Embodiment 1.

TABLE 11

| | | | | Material | | |
|---|---|---|---|---|---|---|
| Surface | Surface | Curvature | Thickness/ | Refractive | Abbe | Conic |
| number | type | radius | distance | index | number | coefficient |
| OBJ | Spherical | Infinite | Infinite | | | |
| STO | Spherical | Infinite | −0.7767 | | | |
| S1 | Aspheric | 3.1803 | 0.8376 | 1.54 | 56.09 | −0.0845 |
| S2 | Aspheric | 5.6964 | 0.0891 | | | −0.5870 |
| S3 | Aspheric | 7.4387 | 0.2680 | 1.57 | 40.00 | 0.0748 |
| S4 | Aspheric | 40.3860 | 0.0500 | | | −99.0000 |
| S5 | Aspheric | 4.5881 | 0.2105 | 1.66 | 20.37 | −0.7257 |
| S6 | Aspheric | 2.8049 | 0.1505 | | | −0.1902 |
| S7 | Aspheric | 8.1436 | 0.7563 | 1.54 | 56.09 | −63.1930 |
| S8 | Aspheric | −37.3726 | 0.2680 | | | −60.7641 |
| S9 | Aspheric | 32.9488 | 0.2100 | 1.64 | 23.80 | −99.0000 |
| S10 | Aspheric | 27.8541 | 0.1459 | | | −99.0000 |
| S11 | Aspheric | −19.0173 | 0.2509 | 1.66 | 20.40 | −87.5301 |
| S12 | Aspheric | −24.2842 | 0.2439 | | | 99.0000 |
| S13 | Aspheric | −19.7756 | 0.9000 | 1.58 | 35.50 | 98.9301 |
| S14 | Aspheric | −7.2949 | 0.3970 | | | −5.2350 |
| S15 | Aspheric | 24.6193 | 0.9562 | 1.67 | 19.00 | −83.8748 |
| S16 | Aspheric | −26.7330 | 0.6650 | | | 28.6027 |
| S17 | Aspheric | −11.7336 | 0.6667 | 1.66 | 20.40 | 0.7427 |
| S18 | Aspheric | −14.3574 | 0.3977 | | | 8.3292 |
| S19 | Aspheric | −5.4031 | 0.4759 | 1.67 | 19.00 | −0.9248 |
| S20 | Aspheric | 7.8720 | 0.1236 | | | −31.8956 |
| S21 | Spherical | Infinite | 0.2100 | 1.52 | 54.20 | |
| S22 | Spherical | Infinite | 0.6000 | | | |
| S23 | Spherical | Infinite | | | | |

TABLE 12

| Surface | | | | | |
|---|---|---|---|---|---|
| number | A4 | A6 | A8 | A10 | A12 |
| S1 | 1.0954E−04 | −3.8347E−04 | 3.1249E−04 | −2.5809E−04 | 1.2613E−04 |
| S2 | −2.7323E−03 | −1.2682E−03 | −5.8849E−03 | 5.5467E−03 | −2.4054E−03 |
| S3 | 2.7345E−03 | 1.4473E−03 | −1.1821E−02 | 10846E−02 | −5.1570E−03 |
| S4 | 3.8160E−02 | −2.0247E−02 | 1.1043E−02 | −4.6231E−03 | 1.5363E−03 |
| S5 | −1.4801E−02 | −4.1647E−03 | 4.5668E−03 | −3.5935E−03 | 2.3327E−03 |
| S6 | −3.9293E−02 | 1.7783E−02 | −1.4149E−02 | 8.6241E−03 | −3.9758E−03 |
| S7 | 2.7740E−02 | −5.4663E−03 | 1.7760E−03 | 2.5436E−04 | −1.3011E−03 |
| S8 | −3.8627E−03 | −2.6679E−03 | 3.8564E−03 | −2.2319E−03 | 7.4583E−04 |
| S9 | −1.1905E−02 | −1.6217E−02 | 1.6262E−02 | −1.0601E−02 | 4.7567E−03 |
| S10 | 10819E−02 | −2.9561E−02 | 2.8264E−02 | −1.6633E−02 | 6.1381E−03 |
| S11 | 1.7170E−02 | −3.7279E−02 | 3.5329E−02 | −2.0250E−02 | 6.7427E−03 |
| S12 | 4.5673E−03 | −3.4701E−02 | 3.0422E−02 | −1.6066E−02 | 4.8844E−03 |
| S13 | −1.1469E−04 | −2.3426E−02 | 1.7357E−02 | −9.2339E−03 | 3.5631E−03 |
| S14 | 5.1047E−03 | −2.5843E−02 | 1.6668E−02 | −7.4715E−03 | 2.4265E−03 |
| S15 | 1.8301E−02 | −2.4191E−02 | 1.0693E−02 | −3.1120E−03 | 6.1905E−04 |
| S16 | 2.3998E−02 | −1.7933E−02 | 5.5348E−03 | −1.0545E−03 | 1.2805E−04 |
| S17 | 7.7385E−03 | −8.9380E−03 | 1.3898E−03 | −9.9836E−05 | 7.7098E−06 |
| S18 | 5.8739E−03 | 1.6026E−03 | −8.3857E−04 | 1.5609E−04 | −1.6983E−05 |
| S19 | −1.0866E−02 | 8.1936E−03 | −1.7504E−03 | 1.9756E−04 | −1.3249E−05 |
| S20 | −8.9100E−03 | 1.4434E−03 | −2.5063E−04 | 2.5644E−05 | −1.4600E−06 |

| Surface | | | | |
|---|---|---|---|---|
| number | A14 | A16 | A18 | A20 |
| S1 | −3.5985E−05 | 5.7250E−06 | −4.6329E−07 | 1.4772E−08 |
| S2 | 6.1250E−04 | −9.4473E−05 | 8.3244E−06 | −3.2580E−07 |
| S3 | 1.4535E−03 | −2.4371E−04 | 2.2595E−05 | −8.9876E−07 |
| S4 | −4.8762E−04 | 1.1834E−04 | −1.6188E−05 | 9.0246E−07 |
| S5 | −1.0155E−03 | 2.5691E−04 | −3.3919E−05 | 1.8140E−06 |
| S6 | 1.2569E−03 | −2.4709E−04 | 2.6946E−05 | −1.2445E−06 |
| S7 | 8.5241E−04 | −2.4758E−04 | 3.4687E−05 | −1.9126E−06 |
| S8 | −1.1833E−04 | 3.9998E−06 | 8.9610E−07 | −7.1094E−08 |
| S9 | −1.4470E−03 | 2.8387E−04 | −3.1902E−05 | 1.5526E−06 |
| S10 | −1.3959E−03 | 1.8932E−04 | −1.4015E−05 | 4.3484E−07 |
| S11 | −1.2254E−03 | 1.0678E−04 | −2.3637E−06 | −1.3180E−07 |
| S12 | −7.4640E−04 | 3.1329E−05 | 5.0620E−06 | −4.7859E−07 |
| S13 | −1.0904E−03 | 2.5964E−04 | −4.0097E−05 | 2.7370E−06 |
| S14 | −5.6757E−04 | 8.9265E−05 | −8.3658E−06 | 3.4880E−07 |
| S15 | −8.3481E−05 | 7.0401E−06 | −3.1901E−07 | 5.5866E−09 |
| S16 | −9.6983E−06 | 4.4241E−07 | −1.1208E−08 | 1.2257E−10 |
| S17 | −7.4698E−07 | 4.5008E−08 | −1.3262E−09 | 1.5054E−11 |
| S18 | 1.1711E−06 | −5.0275E−08 | 1.2198E−09 | −1.2714E−11 |
| S19 | 5.4347E−07 | −1.3283E−08 | 1.7438E−10 | −9.0669E−13 |
| S20 | 4.8167E−08 | −9.1945E−10 | 9.4383E−12 | −4.0350E−14 |

FIG. 12A shows an a longitudinal aberration curve of a camera lens assembly of Embodiment 6, and the longitudinal aberration curve represents a convergence focus deviation formed when different wavelengths of light pass through the lens. FIG. 12B shows a lateral color curve of a camera lens assembly of Embodiment 6, and the lateral color curve represents a deviation of different image heights on an imaging surface when a light passes through the lens. FIG. 12C shows an astigmatism curve of a camera lens assembly of Embodiment 6, and the astigmatism curve represents tangential image surface curvature and sagittal image surface curvature. FIG. 12D shows a distortion curve of a camera lens assembly of Embodiment 6, and the distortion curve represents distortion values corresponding to different fields of view. It may be seen according to FIG. 12A to FIG. 12D that the camera lens assembly provided in Embodiment 6 can achieve good imaging quality.

### Embodiment 7

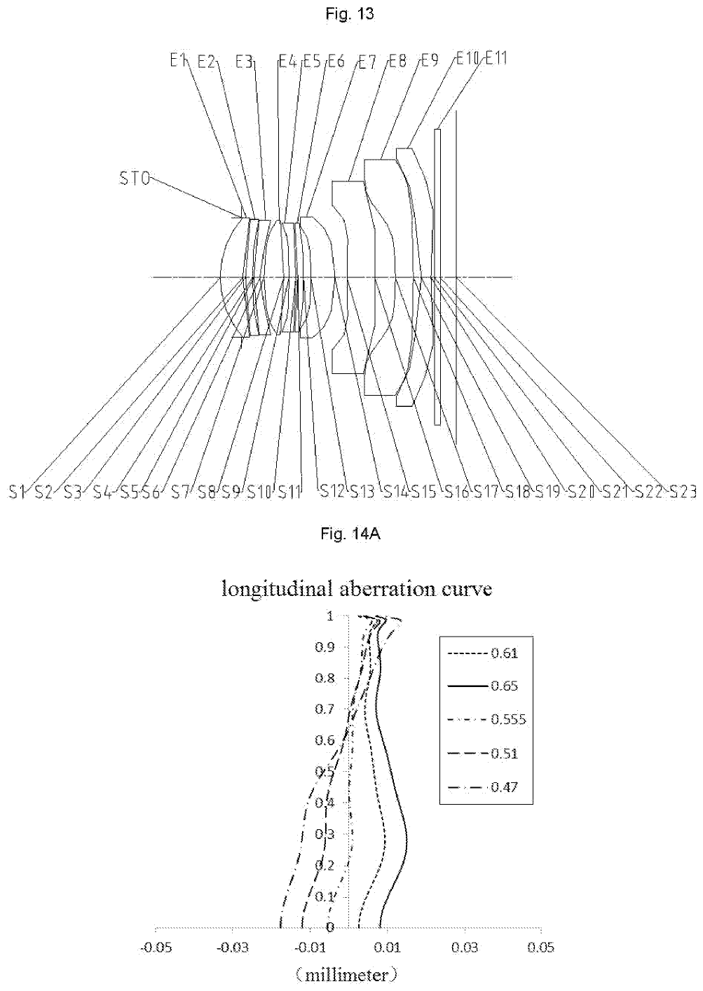

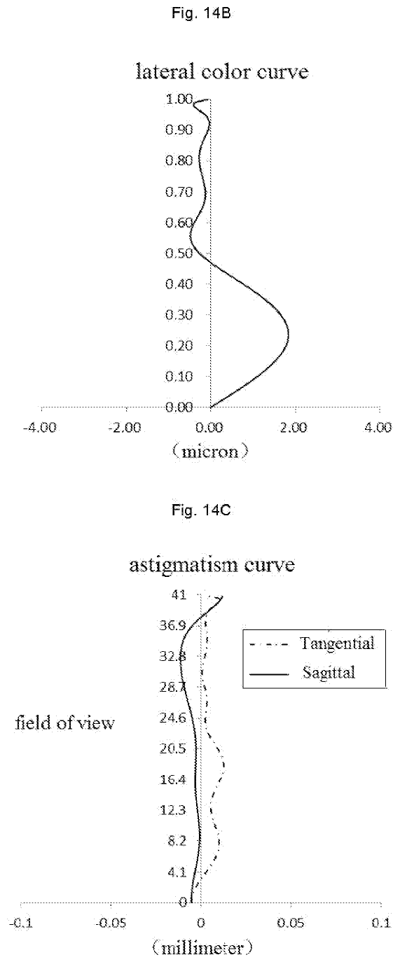

The following describes the camera lens assembly of Embodiment 7 of the disclosure with reference to FIG. 13 to FIG. 14D. FIG. 13 is a schematic structural diagram of a camera lens assembly according to Embodiment 7 of the disclosure.

As shown in FIG. 13, the camera lens assembly includes a diaphragm STO, a first lens E1, a second lens E2, a third lens E3, a fourth lens E4, a fifth lens E5, a sixth lens E6, a seventh lens E7, an eighth lens E8, a ninth lens E9, a tenth lens E10, and a optical filter E11 in sequence from an object side to an image side along an optical axis.

The first lens E1 has a positive refractive power, an object-side surface S1 of the first lens is convex surface, and an image-side surface S2 of the first lens is concave surface. The second lens E2 has a positive refractive power, an object-side surface S3 of the second lens is convex surface, and an image-side surface S4 of the second lens is concave surface. The third lens E3 has a negative refractive power, an object-side surface S5 of the third lens is convex surface, and an image-side surface S6 of the third lens is concave surface. The fourth lens E4 has a positive refractive power, an object-side surface S7 of the fourth lens is convex surface, and an image-side surface S8 of the fourth lens is convex surface. The fifth lens E5 has a positive refractive power, an object-side surface S9 of the fifth lens is convex surface, and an image-side surface S10 of the fifth lens is convex surface. The sixth lens E6 has a negative refractive power, an object-side surface S11 of the sixth lens is concave surface, and an image-side surface S12 of the sixth lens is convex surface. The seventh lens E7 has a positive refractive power, an object-side surface S13 of the seventh lens is concave surface, and an image-side surface S14 of the seventh lens is convex surface. The eighth lens E8 has a positive refractive power, an object-side surface S15 of the eighth lens is convex surface, and an image-side surface S16 of the eighth lens is convex surface. The ninth lens E9 has a negative refractive power, an object-side surface S17 of the ninth lens is concave surface, and an image-side surface S18 of the ninth lens is convex surface. The tenth lens E10 has a negative refractive power, an object-side surface S19 of the tenth lens is concave surface, and an image-side surface S20 of the tenth lens is concave surface. The optical filter E11 has an object-side surface S21 and an image-side surface S22. The camera lens assembly has an imaging surface S23, and a light from an object sequentially passes through the surface S1 to the surface S22 and finally imaged on the imaging surface S23.

In Embodiment 7, a total effective focal length f of the camera lens assembly is 6.91 mm, ImgH is a half of a diagonal length of an effective pixel region on the imaging surface S23, ImgH is 6.10 mm, and FOV is a maximum field of view, FOV is 81.65°.

Table 13 shows basic parameters of the camera lens assembly of Embodiment 7, where both a curvature radius and a thickness/distance are in millimeters (mm). Table 14 shows high-order coefficients that may be used for all aspheric mirror surfaces in Embodiment 7, where each aspheric surface type may be defined by the formula (1) in the Embodiment 1.

TABLE 13

| | | | | Material | | |
|---|---|---|---|---|---|---|
| Surface | Surface | Curvature | Thickness/ | Refractive | Abbe | Conic |
| number | type | radius | distance | index | number | coefficient |
| OBJ | Spherical | Infinite | Infinite | | | |
| STO | Spherical | Infinite | −0.7777 | | | |
| S1 | Aspheric | 3.1778 | 0.8332 | 1.54 | 56.10 | −0.0230 |
| S2 | Aspheric | 5.6129 | 0.1008 | | | −0.9705 |
| S3 | Aspheric | 7.5057 | 0.2636 | 1.57 | 39.50 | 0.5529 |
| S4 | Aspheric | 43.9871 | 0.0500 | | | −11.5062 |
| S5 | Aspheric | 4.6213 | 0.2325 | 1.66 | 20.40 | −1.7466 |
| S6 | Aspheric | 2.8523 | 0.1492 | | | −0.0873 |
| S7 | Aspheric | 10.2002 | 0.7367 | 1.54 | 56.10 | −98.3446 |
| S8 | Aspheric | −19.8690 | 0.1958 | | | 64.8805 |
| S9 | Aspheric | 112.9118 | 0.2514 | 1.64 | 23.80 | 93.1720 |
| S10 | Aspheric | −86.3555 | 0.0759 | | | 77.1318 |
| S11 | Aspheric | −21.5790 | 0.2100 | 1.66 | 20.40 | −48.0456 |
| S12 | Aspheric | −108.1854 | 0.2798 | | | 99.0000 |
| S13 | Aspheric | −15.7370 | 0.8997 | 1.59 | 31.20 | 46.0717 |
| S14 | Aspheric | −7.0556 | 0.4441 | | | 3.4457 |
| S15 | Aspheric | 15.1267 | 1.0375 | 1.67 | 19.00 | −19.7814 |
| S16 | Aspheric | −101.1932 | 0.7721 | | | 99.0000 |
| S17 | Aspheric | −14.1211 | 0.6667 | 1.66 | 20.40 | −2.2075 |
| S18 | Aspheric | −31.4651 | 0.3038 | | | −99.0000 |
| S19 | Aspheric | −7.0784 | 0.3592 | 1.67 | 19.00 | −0.4454 |
| S20 | Aspheric | 7.2455 | 0.1305 | | | −52.4695 |
| S21 | Spherical | Infinite | 0.2100 | 1.52 | 54.20 | |
| S22 | Spherical | Infinite | 0.6000 | | | |
| S23 | Spherical | Infinite | | | | |

TABLE 14

| Surface | | | | | |
|---|---|---|---|---|---|
| number | A4 | A6 | A8 | A10 | A12 |
| S1 | −4.3999E−04 | 2.9548E−05 | −2.4436E−04 | 1.4839E−04 | −4.8106E−05 |
| S2 | −2.3366E−03 | −4.0579E−03 | −5.1556E−03 | 6.4679E−03 | −3.2034E−03 |
| S3 | 8.4195E−03 | −6.9590E−03 | −6.1420E−03 | 8.8267E−03 | −4.9709E−03 |
| S4 | 4.2984E−02 | −2.5206E−02 | 1.8798E−02 | −1.1314E−02 | 4.7567E−03 |
| S5 | −1.6356E−02 | 1.9904E−04 | 4.5727E−03 | −6.5215E−03 | 4.6227E−03 |
| S6 | −4.2741E−02 | 2.3992E−02 | −1.9615E−02 | 1.1496E−02 | −5.0752E−03 |
| S7 | 2.5025E−02 | −2.4962E−03 | −1.7505E−03 | 3.2462E−03 | −3.0970E−03 |
| S8 | −4.5546E−03 | −1.6498E−03 | 1.6353E−03 | −1.0882E−04 | −3.3737E−04 |
| S9 | −1.8852E−02 | −2.0469E−03 | −1.1455E−03 | 3.5912E−03 | −2.5527E−03 |
| S10 | 2.9862E−03 | 1.4127E−03 | −2.6582E−03 | 7.9291E−04 | −1.0923E−04 |
| S11 | 5.2434E−03 | 3.1072E−03 | −3.9110E−03 | 2.0643E−04 | 2.7242E−05 |
| S12 | −9.6672E−03 | −3.3321E−03 | 2.4125E−03 | −2.3311E−03 | 1.0091E−03 |
| S13 | −7.5290E−03 | −7.3119E−03 | 5.0202E−03 | −3.3806E−03 | 1.5861E−03 |
| S14 | −4.4982E−03 | −1.2761E−02 | 8.6034E−03 | −4.3112E−03 | 1.5964E−03 |
| S15 | 6.3127E−03 | −1.2334E−02 | 4.1324E−03 | −8.7993E−04 | 9.1485E−05 |
| S16 | 1.8824E−02 | −1.1230E−02 | 2.7896E−03 | −4.7435E−04 | 5.6501E−05 |
| S17 | 2.3097E−03 | −7.6586E−03 | 1.0388E−03 | −1.6563E−05 | −2.4314E−06 |
| S18 | 6.7897E−03 | −2.2394E−03 | 3.2142E−04 | −2.6571E−05 | 1.2815E−06 |
| S19 | −8.4146E−03 | 7.6409E−03 | −1.9036E−03 | 2.6116E−04 | −2.2213E−05 |
| S20 | −5.2183E−03 | 3.4785E−04 | −5.3909E−05 | 5.8512E−06 | −3.6865E−07 |

| Surface | | | | |
|---|---|---|---|---|
| number | A14 | A16 | A18 | A20 |
| S1 | 8.9118E−06 | −9.2319E−07 | 4.9721E−08 | −1.0927E−09 |
| S2 | 9.1543E−04 | −1.5899E−04 | 1.5712E−05 | −6.7656E−07 |
| S3 | 1.5892E−03 | −3.0075E−04 | 3.1557E−05 | −1.4203E−06 |
| S4 | −1.4596E−03 | 3.0941E−04 | −3.8881E−05 | 2.1209E−06 |
| S5 | −1.9196E−03 | 4.6710E−04 | −6.1345E−05 | 3.3565E−06 |
| S6 | 1.5606E−03 | −3.0003E−04 | 3.1821E−05 | −1.4119E−06 |
| S7 | 1.5324E−03 | −3.9930E−04 | 5.3033E−05 | −2.8479E−06 |
| S8 | 2.0921E−04 | −5.4346E−05 | 6.4976E−06 | −2.9310E−07 |
| S9 | 8.8260E−04 | −1.5889E−04 | 1.3489E−05 | −3.4780E−07 |
| S10 | 8.3219E−06 | −3.6311E−07 | 8.5337E−09 | −8.4004E−11 |
| S11 | 1.9516E−04 | −7.8617E−05 | 1.1043E−05 | −5.3822E−07 |
| S12 | −2.8146E−04 | 8.9628E−05 | −1.9766E−05 | 1.7000E−06 |
| S13 | −6.2486E−04 | 1.8900E−04 | −3.3966E−05 | 2.4949E−06 |
| S14 | −4.2511E−04 | 7.5057E−05 | −7.7777E−06 | 3.5335E−07 |
| S15 | 4.3384E−06 | −2.5849E−06 | 2.8837E−07 | −1.0833E−08 |
| S16 | −4.3892E−06 | 2.0842E−07 | −5.4971E−09 | 6.1953E−11 |
| S17 | −1.8748E−07 | 3.6916E−08 | −1.6967E−09 | 2.6110E−11 |
| S18 | −3.6568E−08 | 6.0945E−10 | −5.4929E−12 | 2.0708E−14 |
| S19 | 1.1886E−06 | −3.8746E−08 | 7.0023E−10 | −5.3610E−12 |
| S20 | 1.4102E−08 | −3.1814E−10 | 3.8573E−12 | −1.9310E−14 |

FIG. 14A shows an a longitudinal aberration curve of a camera lens assembly of Embodiment 7, and the longitudinal aberration curve represents a convergence focus deviation formed when different wavelengths of light pass through the lens. FIG. 14B shows a lateral color curve of a camera lens assembly of Embodiment 7, and the lateral color curve represents a deviation of different image heights on an imaging surface when a light passes through the lens. FIG. 14C shows an astigmatism curve of a camera lens assembly of Embodiment 7, and the astigmatism curve represents tangential image surface curvature and sagittal image surface curvature. FIG. 14D shows a distortion curve of a camera lens assembly of Embodiment 7, and the distortion curve represents distortion values corresponding to different fields of view. It may be seen according to FIG. 14A to FIG. 14D that the camera lens assembly provided in Embodiment 7 can achieve good imaging quality.

### Embodiment 8

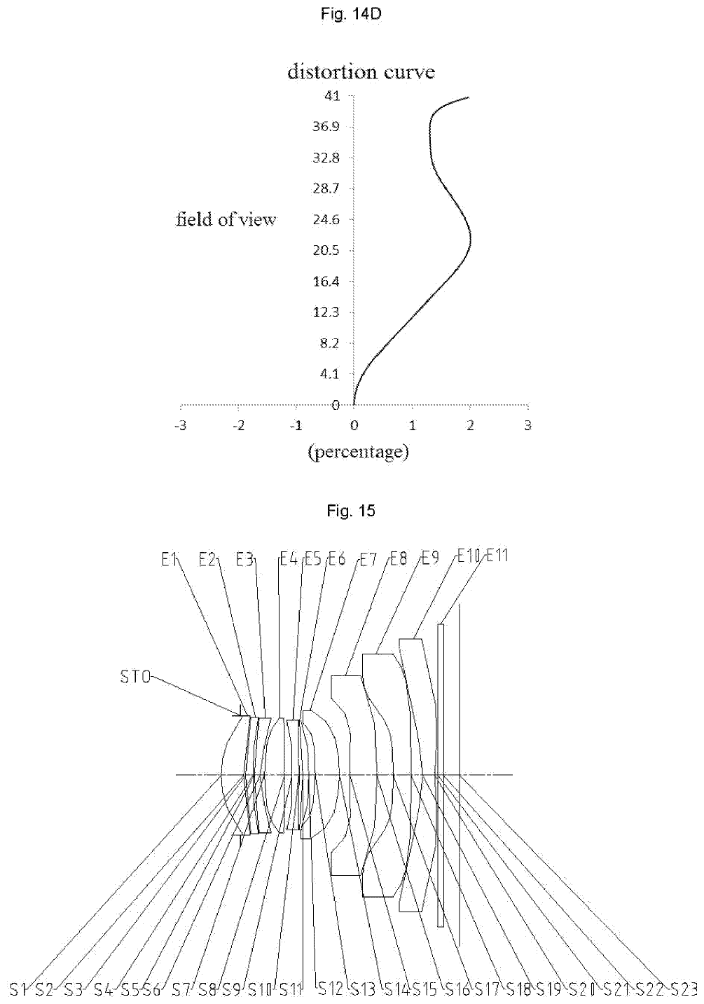

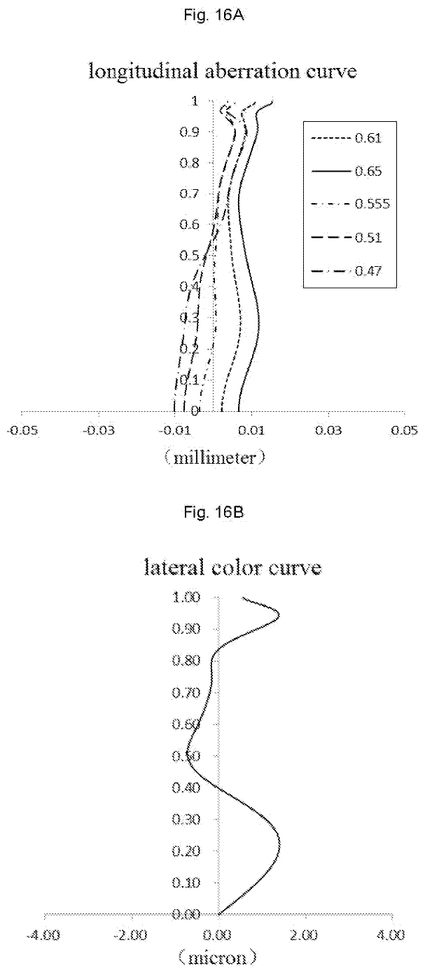

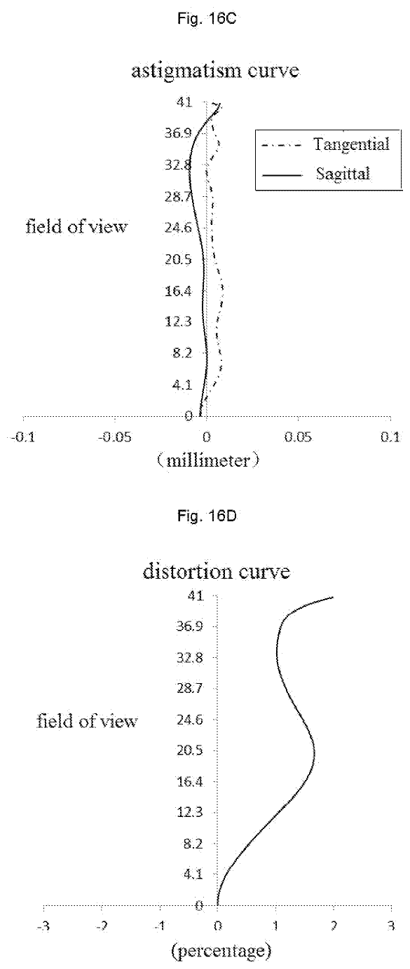

The following describes the camera lens assembly of Embodiment 8 of the disclosure with reference to FIG. 15 to FIG. 16D. FIG. 15 is a schematic structural diagram of a camera lens assembly according to Embodiment 8 of the disclosure.

As shown in FIG. 15, the camera lens assembly includes a diaphragm STO, a first lens E1, a second lens E2, a third lens E3, a fourth lens E4, a fifth lens E5, a sixth lens E6, a seventh lens E7, an eighth lens E8, a ninth lens E9, a tenth lens E10, and a optical filter E11 in sequence from an object side to an image side along an optical axis.

The first lens E1 has a positive refractive power, an object-side surface S1 of the first lens is convex surface, and an image-side surface S2 of the first lens is concave surface. The second lens E2 has a positive refractive power, an object-side surface S3 of the second lens is convex surface, and an image-side surface S4 of the second lens is concave surface. The third lens E3 has a negative refractive power, an object-side surface S5 of the third lens is convex surface, and an image-side surface S6 of the third lens is concave surface. The fourth lens E4 has a positive refractive power, an object-side surface S7 of the fourth lens is convex surface, and an image-side surface S8 of the fourth lens is convex surface. The fifth lens E5 has a positive refractive power, an object-side surface S9 of the fifth lens is convex surface, and an image-side surface S10 of the fifth lens is concave surface. The sixth lens E6 has a negative refractive power, an object-side surface S11 of the sixth lens is concave surface, and an image-side surface S12 of the sixth lens is convex surface. The seventh lens E7 has a positive refractive power, an object-side surface S13 of the seventh lens is concave surface, and an image-side surface S14 of the seventh lens is convex surface. The eighth lens E8 has a positive refractive power, an object-side surface S15 of the eighth lens is convex surface, and an image-side surface S16 of the eighth lens is convex surface. The ninth lens E9 has a negative refractive power, an object-side surface S17 of the ninth lens is concave surface, and an image-side surface S18 of the ninth lens is convex surface. The tenth lens E10 has a negative refractive power, an object-side surface S19 of the tenth lens is concave surface, and an image-side surface S20 of the tenth lens is concave surface. The optical filter E11 has an object-side surface S21 and an image-side surface S22. The camera lens assembly has an imaging surface S23, and a light from an object sequentially passes through the surface S1 to the surface S22 and finally imaged on the imaging surface S23.

In Embodiment 8, a total effective focal length f of the camera lens assembly is 7.03 mm, ImgH is a half of a diagonal length of an effective pixel region on the imaging surface S23, ImgH is 6.20 mm, and FOV is a maximum field of view, FOV is 81.65°.

Table 15 shows basic parameters of the camera lens assembly of Embodiment 8, where both a curvature radius and a thickness/distance are in millimeters (mm). Table 16 shows high-order coefficients that may be used for all aspheric mirror surfaces in Embodiment 8, where each aspheric surface type may be defined by the formula (1) in the Embodiment 1.

TABLE 15

| | | | | Material | | |
|---|---|---|---|---|---|---|
| Surface | Surface | Curvature | Thickness/ | Refractive | Abbe | Conic |
| number | type | radius | distance | index | number | coefficient |
| OBJ | Spherical | Infinite | Infinite | | | |
| STO | Spherical | Infinite | −0.7576 | | | |
| S1 | Aspheric | 3.1983 | 0.8374 | 1.54 | 56.10 | −0.1053 |
| S2 | Aspheric | 5.8598 | 0.0781 | | | −0.8775 |
| S3 | Aspheric | 8.0621 | 0.2720 | 1.56 | 40.80 | 1.3672 |
| S4 | Aspheric | 70.2234 | 0.0500 | | | −5.8602 |
| S5 | Aspheric | 4.7053 | 0.2100 | 1.66 | 20.40 | −0.9115 |
| S6 | Aspheric | 2.8268 | 0.1637 | | | −0.2054 |
| S7 | Aspheric | 8.0026 | 0.7532 | 1.54 | 56.10 | −66.7371 |
| S8 | Aspheric | −92.2063 | 0.2793 | | | −97.6916 |
| S9 | Aspheric | 25.1435 | 0.2526 | 1.64 | 23.80 | 80.5990 |
| S10 | Aspheric | 48.8033 | 0.1503 | | | −49.9157 |
| S11 | Aspheric | −14.6581 | 0.2195 | 1.66 | 20.40 | −93.6104 |
| S12 | Aspheric | −20.2892 | 0.2454 | | | 94.5425 |
| S13 | Aspheric | −19.5334 | 0.9000 | 1.57 | 36.50 | 97.5120 |
| S14 | Aspheric | −7.2581 | 0.3934 | | | −5.0589 |
| S15 | Aspheric | 25.9265 | 0.9988 | 1.67 | 19.00 | −99.0000 |
| S16 | Aspheric | −29.1010 | 0.6112 | | | 34.7250 |
| S17 | Aspheric | −13.4338 | 0.6667 | 1.66 | 20.40 | 0.4683 |
| S18 | Aspheric | −19.4232 | 0.4301 | | | −83.2224 |
| S19 | Aspheric | −5.2618 | 0.4480 | 1.67 | 19.00 | −0.9417 |
| S20 | Aspheric | 8.6953 | 0.1162 | | | −58.5329 |
| S21 | Spherical | Infinite | 0.2100 | 1.52 | 54.20 | |
| S22 | Spherical | Infinite | 0.6000 | | | |
| S23 | Spherical | Infinite | | | | |

TABLE 16

| Surface | | | | | |
|---|---|---|---|---|---|
| number | A4 | A6 | A8 | A10 | A12 |
| S1 | −6.3427E−05 | −1.6573E−04 | −8.0188E−05 | 3.4908E−05 | −2.0193E−06 |
| S2 | −2.2709E−03 | −3.2699E−04 | −8.6821E−03 | 8.2602E−03 | −3.9247E−03 |
| S3 | 1.4130E−03 | 4.1677E−03 | −1.6839E−02 | 1.6236E−02 | −8.3962E−03 |
| S4 | 3.6409E−02 | −2.2018E−02 | 1.2183E−02 | −3.4987E−03 | 1.7934E−04 |
| S5 | −1.1308E−02 | −1.1382E−02 | 1.0788E−02 | −6.6175E−03 | 3.2037E−03 |
| S6 | −3.5553E−02 | 1.2541E−02 | −1.0053E−02 | 6.6129E−03 | −3.3086E−03 |
| S7 | 2.8405E−02 | −7.3475E−03 | 3.4809E−03 | −9.1352E−04 | −6.5440E−04 |
| S8 | −6.9592E−03 | −8.8134E−04 | 2.6553E−03 | −1.5112E−03 | 4.6454E−04 |
| S9 | −1.6374E−02 | −1.0103E−02 | 1.0334E−02 | −6.8249E−03 | 2.9241E−03 |
| S10 | 9.7689E−03 | −2.7544E−02 | 2.7634E−02 | −1.6816E−02 | 6.2872E−03 |
| S11 | 2.0919E−02 | −5.1858E−02 | 5.1312E−02 | −2.9999E−02 | 1.0500E−02 |
| S12 | 1.1540E−02 | −5.2406E−02 | 4.8523E−02 | −2.7892E−02 | 1.0281E−02 |
| S13 | 3.2843E−03 | −2.9635E−02 | 2.1495E−02 | −1.0777E−02 | 3.7207E−03 |
| S14 | 7.2855E−03 | −2.7465E−02 | 1.7294E−02 | −7.4319E−03 | 2.2990E−03 |
| S15 | 1.7798E−02 | −2.4656E−02 | 1.0982E−02 | −3.0794E−03 | 5.7944E−04 |
| S16 | 2.4265E−02 | −1.8924E−02 | 5.8363E−03 | −1.0505E−03 | 1.1579E−04 |
| S17 | 1.0132E−02 | −1.0791E−02 | 1.7343E−03 | −9.9254E−05 | 8.6271E−07 |
| S18 | 7.0017E−03 | −9.7201E−04 | −1.9026E−05 | 1.8650E−05 | −3.0299E−06 |
| S19 | −4.6160E−03 | 4.3704E−03 | −6.5696E−04 | 2.8675E−05 | 2.1683E−06 |
| S20 | −3.7657E−03 | −2.5764E−04 | 4.0932E−05 | −1.8691E−06 | 4.2594E−08 |

| Surface | | | | |
|---|---|---|---|---|
| number | A14 | A16 | A18 | A20 |
| S1 | −3.4361E−06 | 1.0500E−06 | −1.1214E−07 | 4.0903E−09 |
| S2 | 1.1317E−03 | −1.9920E−04 | 1.9661E−05 | −8.3093E−07 |
| S3 | 2.6002E−03 | −4.8216E−04 | 4.9471E−05 | −2.1609E−06 |
| S4 | 1.1950E−04 | −2.4930E−05 | 1.5171E−06 | 3.5273E−11 |
| S5 | −1.1575E−03 | 2.6919E−04 | −3.4633E−05 | 1.8593E−06 |
| S6 | 1.1027E−03 | −2.1989E−04 | 2.3224E−05 | −9.7677E−07 |
| S7 | 6.0773E−04 | −1.9000E−04 | 2.7070E−05 | −1.4805E−06 |
| S8 | −5.2812E−05 | −4.4637E−06 | 1.4278E−06 | −8.2510E−08 |
| S9 | −7.9123E−04 | 1.2759E−04 | −1.0129E−05 | 2.2895E−07 |
| S10 | −1.4297E−03 | 1.9245E−04 | −1.4085E−05 | 4.3146E−07 |
| S11 | −2.1497E−03 | 2.4619E−04 | −1.4036E−05 | 2.8204E−07 |
| S12 | −2.4381E−03 | 3.7777E−04 | −3.6722E−05 | 1.7820E−06 |
| S13 | −9.2564E−04 | 1.7062E−04 | −2.1864E−05 | 1.3398E−06 |
| S14 | −5.1365E−04 | 7.7438E−05 | −6.9754E−06 | 2.8036E−07 |
| S15 | −7.4144E−05 | 5.9481E−06 | −2.5086E−07 | 3.7596E−09 |
| S16 | −7.7268E−06 | 3.0076E−07 | −6.2535E−09 | 5.3903E−11 |
| S17 | 1.1393E−07 | −3.2022E−09 | −1.4393E−11 | 9.6206E−13 |
| S18 | 2.8147E−07 | −1.5155E−08 | 4.2983E−10 | −4.9347E−12 |
| S19 | −3.1772E−07 | 1.5696E−08 | −3.6519E−10 | 3.3592E−12 |
| S20 | −5.4337E−10 | 3.9481E−12 | −1.5296E−14 | 2.4567E−17 |

FIG. 16A shows an a longitudinal aberration curve of a camera lens assembly of Embodiment 8, and the longitudinal aberration curve represents a convergence focus deviation formed when different wavelengths of light pass through the lens. FIG. 16B shows a lateral color curve of a camera lens assembly of Embodiment 8, and the lateral color curve represents a deviation of different image heights on an imaging surface when a light passes through the lens. FIG. 16C shows an astigmatism curve of a camera lens assembly of Embodiment 8, and the astigmatism curve represents tangential image surface curvature and sagittal image surface curvature. FIG. 16D shows a distortion curve of a camera lens assembly of Embodiment 8, and the distortion curve represents distortion values corresponding to different fields of view. It may be seen according to FIG. 16A to FIG. 16D that the camera lens assembly provided in Embodiment 8 can achieve good imaging quality.

In addition, in Embodiment 1 to Embodiment 8, focal length values f1 to f10 of each lens are shown in Table 17.

TABLE 17

| Parameters in | | | | | | | | |
|---|---|---|---|---|---|---|---|---|
| the embodiments | 1 | 2 | 3 | 4 | 5 | 6 | 7 | 8 |
| f1 (mm) | 15.28 | 11.70 | 12.15 | 21.75 | 9.46 | 11.80 | 11.97 | 11.61 |
| f2 (mm) | 13.33 | 16.66 | 15.47 | 9.83 | 17.03 | 15.98 | 15.84 | 16.03 |
| f3 (mm) | −12.61 | −11.74 | −11.50 | −11.31 | −9.11 | −11.36 | −11.80 | −11.12 |
| f4 (mm) | 15.87 | 12.39 | 13.71 | 13.21 | 12.72 | 12.32 | 12.45 | 13.52 |
| f5 (mm) | −146.37 | 168.11 | −122.03 | 56.26 | 115.03 | −286.23 | 76.54 | 80.75 |
| f6 (mm) | −223.11 | −52.22 | −7289.98 | −30.07 | −32.04 | −134.11 | −40.48 | −80.49 |
| f7 (mm) | 16.64 | 18.90 | 17.71 | 16.94 | 14.71 | 19.43 | 20.76 | 19.49 |
| f8 (mm) | 17.21 | 21.42 | 19.06 | 20.20 | 19.52 | 19.09 | 19.53 | 20.42 |
| f9 (mm) | 142.27 | −73.18 | −97.94 | −98.84 | −366.37 | −107.22 | −39.04 | −68.41 |
| f10 (mm) | −4.35 | −5.00 | −4.83 | −4.84 | −4.40 | −4.67 | −5.24 | −4.79 |

Embodiment 1 to Embodiment 8 respectively satisfy relationships shown in Table 18.

TABLE 18

| Conditional | | | | | | | | |
|---|---|---|---|---|---|---|---|---|
| formula/ | | | | | | | | |
| Embodiment | 1 | 2 | 3 | 4 | 5 | 6 | 7 | 8 |
| ImgH (mm) | 6.06 | 6.14 | 6.09 | 6.13 | 6.01 | 6.20 | 6.10 | 6.20 |
| \|DIST\| (%) | 1.97 | 2.03 | 2.05 | 1.97 | 1.98 | 1.98 | 2.00 | 1.98 |
| ImgH/EPD | 1.42 | 1.42 | 1.42 | 1.42 | 1.42 | 1.42 | 1.42 | 1.44 |
| f*tan(Semi-FOV) (mm) | 5.93 | 6.01 | 5.97 | 6.01 | 5.89 | 6.08 | 5.97 | 6.08 |
| TTL/Fno (mm) | 5.42 | 5.48 | 5.47 | 5.46 | 5.35 | 5.51 | 5.47 | 5.52 |
| (R1 + R2)/(R2 − R1) | 4.90 | 3.40 | 3.65 | 9.02 | 2.43 | 3.53 | 3.61 | 3.40 |
| CT1/CT2 | 2.10 | 3.22 | 3.09 | 1.68 | 3.08 | 3.13 | 3.16 | 3.08 |
| f3/(R5 − R6) | −7.60 | −6.67 | −6.28 | −6.83 | −2.30 | −6.37 | −6.67 | −5.92 |
| f/f4 | 2.31 | 1.78 | 1.98 | 1.90 | 1.86 | 1.75 | 1.80 | 1.92 |
| CT7/(CT5 + T45) | 2.04 | 2.00 | 2.34 | 1.80 | 1.40 | 1.88 | 2.01 | 1.69 |
| (R17 + R18)/R17 | 1.90 | 2.36 | 2.23 | 2.22 | 2.08 | 2.22 | 3.23 | 2.45 |
| f/f10 | −1.58 | −1.39 | −1.43 | −1.44 | −1.55 | −1.51 | −1.32 | −1.47 |
| (CT6 + CT8)/f8 | 0.06 | 0.06 | 0.06 | 0.06 | 0.05 | 0.06 | 0.06 | 0.06 |

The disclosure further provides an imaging apparatus provided with an electronic photosensitive element for imaging. The electronic photosensitive element may be a charge coupled device (CCD) or a complementary metal oxide semiconductor (CMOS). The imaging apparatus may be an independent imaging device such as a digital camera, or an imaging module integrated on a mobile electronic device such as a mobile phone. The imaging apparatus is equipped with the camera lens assembly described above.

The foregoing description is only a preferable embodiment of the disclosure and an explanation of the applied technical principles. A person skilled in the art should understand that the scope of protection involved in the disclosure is not limited to the technical solution formed by a specific combination of the foregoing technical features, and should also cover other technical solutions formed by any combination of the foregoing technical features or equivalent features thereof without departing from the concept of the disclosure. For example, a technical solution formed when the foregoing features and the technical features disclosed in the disclosure (but not limited to) with similar functions are mutually replaced.

What is claimed is:

1. A camera lens assembly, sequentially comprising from an object side to an image side along an optical axis: a first lens, a second lens, a third lens, a fourth lens, a fifth lens, a sixth lens, a seventh lens, an eighth lens, a ninth lens and a tenth lens, wherein
the seventh lens has a positive refractive power;
the eighth lens has a positive refractive power;
an object-side surface of the ninth lens is concave surface, and an image-side surface of the ninth lens is convex surface; and
ImgH is a half of a diagonal length of an effective pixel region on an imaging surface of the camera lens assembly, ImgH satisfies: ImgH>6 mm.

2. The camera lens assembly according to claim 1, wherein an optical distortion DIST at a maximum field of view of the camera lens assembly satisfies:

|DIST|≤3%.

3. The camera lens assembly according to claim 1, wherein ImgH and an Entrance Pupil Diameter (EPD) of the camera lens assembly satisfy:
1<ImgH/EPD<1.5.

4. The camera lens assembly according to claim 1, wherein TTL is an on-axis distance from an object-side surface of the first lens to the imaging surface, TTL and an f-number Fno of the camera lens assembly satisfy:
5 mm<TTL/Fno<6 mm.

5. The camera lens assembly according to claim 1, wherein a curvature radius R1 of the object-side surface of the first lens and a curvature radius R2 of an image-side surface of the first lens satisfy:
2<(R1+R2)/(R2−R1)<10.

6. The camera lens assembly according to claim 1, wherein a central thickness CT1 of the first lens and a central thickness CT2 of the second lens satisfy:
1.5<CT1/CT2≤3.5.

7. The camera lens assembly according to claim 1, wherein an effective focal length f3 of the third lens, a curvature radius R5 of an object-side surface of the third lens, and a curvature radius R6 of an image-side surface of the third lens satisfy:
−8<f3/(R5−R6)<−2.

8. The camera lens assembly according to claim 1, wherein an effective focal length f of the camera lens assembly and an effective focal length f4 of the fourth lens satisfy:
1<f/f4<2.5.

9. The camera lens assembly according to claim 1, wherein a central thickness CT5 of the fifth lens, a central thickness CT7 of the seventh lens, and an air space T45 between the fourth lens and the fifth lens on the optical axis satisfy:
1<CT7/(CT5+T45)<2.5.

10. The camera lens assembly according to claim 1, wherein a curvature radius R17 of an object-side surface of the ninth lens and a curvature radius R18 of an image-side surface of the ninth lens satisfy:
1<(R17+R18)/R17<3.5.

11. The camera lens assembly according to claim 1, wherein an effective focal length f of the camera lens assembly and an effective focal length f10 of the tenth lens satisfy:
−2<f/f10<0.

12. The camera lens assembly according to claim 1, wherein a central thickness CT6 of the sixth lens, a central thickness CT8 of the eighth lens, and an effective focal length f8 of the eighth lens satisfy:
0<(CT6+CT8)/f8<0.1.
